(19) United States
(12) Patent Application Publication
(10) Pub. No.: US 2015/0304987 A1
(43) Pub. Date: Oct. 22, 2015

(54) Paging Method and Device in Wireless Communications System

(71) Applicant: Huawei Technologies Co., Ltd., Shenzhen (CN)

(72) Inventor: Weisheng Jin, Shanghai (CN)

(21) Appl. No.: 14/753,946

(22) Filed: Jun. 29, 2015

Related U.S. Application Data
(63) Continuation of application No. PCT/CN2012/088135, filed on Dec. 31, 2012.

(51) Int. Cl. H04W 68/02; H04W 76/02; H04W 72/04

(52) U.S. Cl. CPC H04W 68/02; H04W 72/042; H04W 76/021; H04W 88/02

(57) ABSTRACT

Embodiments of the present invention provide a paging method and device in a wireless communications system. The paging method includes: acquiring, by a network side device, network information and determining target network indication information according to the network information; and adding, by the network side device, the target network indication information to a first paging message, and sending the first paging message to user equipment UE for the UE determining a cell according to the target network indication information, and initiating a service request or responding to paging in the determined cell. The paging method and device provided by the embodiments of the present invention avoid restriction on network resource allocation, thereby improving a paging effect.

This application is a continuation of International Application No. PCT/CN2012/088135, filed on Dec. 31, 2012, which is hereby incorporated by reference in its entirety.

### TECHNICAL FIELD

Embodiments of the present invention relate to communications technologies, and in particular, to a paging method and device in a wireless communications system.

### BACKGROUND

With development of communications technologies, the 3rd Generation Partnership Project (Third Generation Partnership Project, 3GPP for short) carries out research and standardization work on 3G Long Term Evolution (Long Term Evolution, LTE for short) technologies, expecting to obtain a higher speed, a larger capacity, and better user performance. At an initial stage of LTE deployment, an LTE network is deployed only in a hotspot area, while a 2G/3G network is deployed for full coverage. In an area with multiple overlapped or neighboring wireless networks, a UE (User Equipment, user equipment) can move back and forth between the LTE network and the 2G/3G network.

When the UE switches to an idle state, the UE camps of a specific network standard, and can monitor paging only in the cell of the network standard, respond to paging in this cell when paging arrives, and establish an air interface connection. A network directly allocates a resource to the UE in this cell. However, cell resources of this network standard may be insufficient, or an air interface condition of this network standard may be limited, which cannot meet a requirement of using a service in a connected state.

### SUMMARY

Embodiments of the present invention provide a paging method and device in a wireless communications system, so as to avoid restriction, on network resource allocation, caused by that UE can only wait for paging and respond in a cell of a network standard used when the UE camps in an idle state and when the UE receives a paging message, thereby improving a paging effect.

According to a first aspect, an embodiment of the present invention provides a paging method in a wireless communications system, including:

acquiring, by a network side device, network information and determining target network indication information according to the network information; and

adding, by the network side device, the target network indication information to a first paging message, and sending the first paging message to user equipment UE, so that the UE determines a cell according to the target network indication information, and initiates a service request or responds to paging in the determined cell.

With reference to the first aspect, in a first possible implementation manner, the network information includes at least one of the following:

service type information of downlink data that triggers the paging and information about a network resource situation of an access network.

With reference to the first possible implementation manner of the first aspect, in a second possible implementation manner, the network information includes the service type information, and the network side device is a mobility management node; and

the acquiring, by a network side device, network information includes:

determining, by the mobility management node according to a bearer identifier carried in a received downlink data notification message sent by a serving gateway S-GW, an access point name APN to which the downlink data belongs, and determining the service type information according to the APN; or

determining, by the mobility management node according to a bearer identifier carried in a received downlink data notification message sent by an S-GW, a quality of service class identifier QCI to which the downlink data belongs, and determining the service type information according to the QCI; or

determining, by the mobility management node, the service type information according to a received downlink data notification message sent by an S-GW, where the downlink data notification message carries the service type information.

With reference to the first possible implementation manner of the first aspect, in a third possible implementation manner, the network information includes the service type information, and the network side device is a single radio controller SRC;

the acquiring, by a network side device, network information includes:

determining, by the SRC, the service type information according to a received second paging message sent by a mobility management node or an access network device, where the second paging message carries the service type information; and

the adding, by the network side device, the target network indication information to a first paging message, and sending the first paging message to user equipment UE includes:

adding, by the SRC, the target network indication information to the first paging message, and sending the first paging message to the UE by using the access network device.

With reference to the first possible implementation manner of the first aspect, in a fourth possible implementation manner, the network information further includes activation indication information that is used to indicate whether idle state signaling reduction ISR of the UE is activated, and the network side device is a single radio controller SRC;

the acquiring, by a network side device, network information and determining target network indication information according to the network information includes:

determining, by the SRC, the activation indication information according to a received second paging message sent by a mobility management node or an access network device, and determining the target network indication information according to the service type information and the activation indication information, where the second paging message carries the activation indication information; and

the adding, by the network side device, the target network indication information to a first paging message, and sending the first paging message to user equipment UE includes:

adding, by the SRC, the target network indication information to the first paging message, and sending the first paging message to the UE by using the access network device.

With reference to the first possible implementation manner of the first aspect, in a fifth possible implementation manner, the network information includes the service type information, and the network side device is an access network device; and

the acquiring, by a network side device, network information includes:

determining, by the access network device, the service type information according to a received second paging message sent by a mobility management node or an SRC, where the second paging message carries the service type information.

With reference to the first aspect, in a sixth possible implementation manner, the target network indication information includes:

network standard indication information; or

network standard indication information and frequency indication information; or

network standard indication information and cell indication information.

According to a second aspect, an embodiment of the present invention provides a paging method in a wireless communications system, including:

receiving, by user equipment UE, a paging message that is sent by a network side device and that carries target network indication information; and

determining, by the UE, a cell according to the target network indication information, and initiating a service request or responding to paging in the determined cell.

With reference to the second aspect, in a first possible implementation manner, the target network indication information includes network standard indication information; and

the determining, by the UE, a cell according to the target network indication information, and initiating a service request or responding to paging in the determined cell includes:

if the UE determines that idle state signaling reduction ISR is activated and that a first network standard indicated by the network standard indication information is different from a second network standard used when the UE camps in an idle state and when the UE receives the paging message, selecting a first cell that is of the first network standard and whose signal quality meets a preset stipulation; and if the first cell is a cell in a location area with which the UE is registered, initiating the service request or responding to the paging in the first cell; or

if the UE determines that ISR is activated and that a first network standard indicated by the network standard indication information is different from a second network standard used when the UE camps in an idle state and when the UE receives the paging message, and if signal quality of any cell of the first network standard does not meet a preset stipulation, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting a first cell that is of the first network standard and whose signal quality meets a preset stipulation; and if the first cell is not a cell in a location area with which the UE is registered, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting the N^{th} cell that is of the first network standard and whose signal quality meets a preset stipulation; if the N^{th} cell is not a cell in a location area with which the UE is registered, selecting the (N+1)^{th} cell that is of the first network standard and whose signal quality meets the preset stipulation; and if the (N+1)^{th} cell is a cell in the location area with which the UE is registered, initiating the service request or responding to the paging in the (N+1)^{th} cell, where N is an integer, 1≦N≦M, and a quantity of cells that are of the first network standard and whose signal quality meets the preset stipulation is M; or

if the UE determines that ISR is activated and that a first network standard indicated by the network standard indication information is different from a second network standard used when the UE camps in an idle state and when the UE receives the paging message, and if none of cells that are of the first network standard and whose signal quality meets a preset stipulation is a cell in a location area with which the UE is registered, initiating the service request or responding to the paging in a cell of the second network standard used when the UE camps in the idle state and when the UE receives the paging message.

With reference to the second aspect, in a second possible implementation manner, the target network indication information includes network standard indication information; and

the determining, by the UE, a cell according to the target network indication information, and initiating a service request or responding to paging in the determined cell includes:

if the UE determines that ISR is not activated and that a first network standard indicated by the network standard indication information is different from a second network standard used when the UE camps in an idle state and when the UE receives the paging message, initiating the service request or responding to the paging in a cell of the second network standard used when the UE camps in the idle state and when the UE receives the paging message.

With reference to the second aspect, in a third possible implementation manner, the target network indication information includes network standard indication information and frequency indication information; and

the determining, by the UE, a cell according to the target network indication information, and initiating a service request or responding to paging in the determined cell includes:

if the UE determines that ISR is activated and that a first network standard indicated by the network standard indication information is different from a second network standard used when the UE camps in an idle state and when the UE receives the paging message, selecting a first cell that is of the first network standard, that is of a frequency indicated by the frequency indication information, and whose signal quality meets a preset stipulation; and if the first cell is a cell in a location area with which the UE is registered, initiating the service request or responding to the paging in the first cell; or

if the UE determines that ISR is activated and that a first network standard indicated by the network standard indication information is different from a second network standard used when the UE camps in an idle state and when the UE receives the paging message, and if signal quality of any cell that is of the first network standard and that is of a frequency indicated by the frequency indication information does not meet a preset stipulation, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting a first cell that is of the first network standard, that is of a frequency indicated by the frequency indication information, and whose signal quality meets a preset stipulation; and if the first cell is not a cell in a location area with which the UE is registered, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting the I^{th} cell that is of the first network standard, that is of a frequency indicated by the frequency indication information, and whose signal quality meets a preset stipulation; if the I^{th} cell is not a cell in a location area with which the UE is registered, selecting the (I+1)^{th} cell that is of the frequency and whose signal quality meets the preset stipulation; and if the (I+1)^{th} cell is a cell in the location area with which the UE is registered, initiating the service request or responding to the paging in the (I+1)^{th} cell, where I is an integer, 1≦I≦J, and a quantity of cells that are of the frequency and whose signal quality meets the preset stipulation is J; or

if the UE determines that ISR is activated and that a first network standard indicated by the network standard indication information is different from a second network standard used when the UE camps in an idle state and when the UE receives the paging message, and if none of cells that are of the first network standard, that are of a frequency indicated by the frequency indication information, and whose signal quality meets a preset stipulation is a cell in a location area with which the UE is registered, initiating the service request or responding to the paging in a cell of the second network standard used when the UE camps in the idle state and when the UE receives the paging message.

With reference to the second aspect, in a fourth possible implementation manner, the target network indication information includes network standard indication information and frequency indication information; and

the determining, by the UE, a cell according to the target network indication information, and initiating a service request or responding to paging in the determined cell includes:

if the UE determines that a first network standard indicated by the network standard indication information is the same as a second network standard used when the UE camps in an idle state and when the UE receives the paging message, selecting a first cell that is of a frequency indicated by the frequency indication information and whose signal quality meets a preset stipulation; and if the first cell is a cell in a location area with which the UE is registered, initiating the service request or responding to the paging in the first cell; or

if the UE determines that a first network standard indicated by the network standard indication information is the same as a second network standard used when the UE camps in an idle state and when the UE receives the paging message, and if signal quality of any cell that is of the first network standard and that is of a frequency indicated by the frequency indication information does not meet a preset stipulation, initiating the service request or responding to the paging in a cell of the second network standard used when the UE camps in the idle state and when the UE receives the paging message; or

if the UE determines that a first network standard indicated by the network standard indication information is the same as a second network standard used when the UE camps in an idle state and when the UE receives the paging message, selecting a first cell that is of a frequency indicated by the frequency indication information and whose signal quality meets a preset stipulation; and if the first cell is not a cell in a location area with which the UE is registered, initiating the service request or responding to the paging in a cell of the second network standard used when the UE camps in the idle state and when the UE receives the paging message; or

if the UE determines that a first network standard indicated by the network standard indication information is the same as a second network standard used when the UE camps in an idle state and when the UE receives the paging message, selecting the R^{th} cell that is of a frequency indicated by the frequency indication information and whose signal quality meets a preset stipulation; if the R^{th} cell is not a cell in a location area with which the UE is registered, selecting the (R+1)^{th} cell that is of the frequency and whose signal quality meets the preset stipulation; and if the (R+1)^{th} cell is a cell in the location area with which the UE is registered, initiating the service request or responding to the paging in the (R+1)^{th} cell, where R is an integer, 1≦R≦S, and a quantity of cells that are of the frequency and whose signal quality meets the preset stipulation is S.

With reference to the second aspect, in a fifth possible implementation manner, the target network indication information includes network standard indication information and cell indication information; and

the determining, by the UE, a cell according to the target network indication information, and initiating a service request or responding to paging in the determined cell includes:

if the UE determines that: ISR is activated, a first network standard indicated by the network standard indication information is different from a second network standard used when the UE camps in an idle state and when the UE receives the paging message, signal quality of a first cell indicated by the cell indication information meets a preset stipulation, and the first cell is a cell in a location area with which the UE is registered, initiating the service request or responding to the paging in the first cell; or

if the UE determines that ISR is activated and that a first network standard indicated by the network standard indication information is different from a second network standard used when the UE camps in an idle state and when the UE receives the paging message, and if signal quality of any first cell indicated by the cell indication information does not meet a preset stipulation, initiating the service request or responding to the paging in a cell of the second network standard used when the UE camps in the idle state and when the UE receives the paging message; or

if the UE determines that: ISR is activated, a first network standard indicated by the network standard indication information is different from a second network standard used when the UE camps in an idle state and when the UE receives the paging message, and a first cell indicated by the cell indication information is not a cell in a location area with which the UE is registered, initiating the service request or responding to the paging in a cell of the second network standard used when the UE camps in the idle state and when the UE receives the paging message.

In a sixth possible implementation manner, the target network indication information includes network standard indication information and cell indication information; and the determining, by the UE, a cell according to the target network indication information, and initiating a service request or responding to paging in the determined cell includes:

if the UE determines that ISR is not activated and that a first network standard indicated by the network standard indication information is different from a second network standard used when the UE camps in an idle state and when the UE receives the paging message, initiating the service request or responding to the paging in a cell of the second network standard used when the UE camps in the idle state and when the UE receives the paging message.

In a seventh possible implementation manner, the target network indication information includes network standard indication information and cell indication information; and

the determining, by the UE, a cell according to the target network indication information, and initiating a service request or responding to paging in the determined cell includes:

if the UE determines that: a first network standard indicated by the network standard indication information is the same as a second network standard used when the UE camps in an idle state and when the UE receives the paging message, signal quality of a first cell indicated by the cell indication information meets a preset stipulation, and the first cell is a cell in a location area with which the UE is registered, initiating the service request or responding to the paging in the first cell; or

if the UE determines that a first network standard indicated by the network standard indication information is the same as a second network standard used when the UE camps in an idle state and when the UE receives the paging message, and if signal quality of a first cell indicated by the cell indication information does not meet a preset stipulation, initiating the service request or responding to the paging in a cell of the second network standard used when the UE camps in the idle state and when the UE receives the paging message; or

if the UE determines that a first network standard indicated by the network standard indication information is the same as a second network standard used when the UE camps in an idle state and when the UE receives the paging message, and if a first cell indicated by the cell indication information is not a cell in a location area with which the UE is registered, initiating the service request or responding to the paging in a cell of the second network standard used when the UE camps in the idle state and when the UE receives the paging message.

According to a third aspect, an embodiment of the present invention provides a network side device, including:

an acquiring unit, configured to acquire network information and determine target network indication information according to the network information; and

a sending unit, configured to add the target network indication information to a first paging message, and send the first paging message to user equipment UE, so that the UE determines a cell according to the target network indication information, and initiates a service request or responds to paging in the determined cell.

With reference to the third aspect, in a first possible implementation manner, the network information includes at least one of the following:

service type information of downlink data that triggers the paging and information about a network resource situation of an access network.

With reference to the first possible implementation manner of the third aspect, in a second possible implementation manner, the network information includes the service type information, and the network side device is a mobility management node; and

the acquiring unit is further configured to determine, according to a bearer identifier carried in a received downlink data notification message sent by a serving gateway S-GW, an access point name APN to which the downlink data belongs, and determine the service type information according to the APN; or

determine, according to a bearer identifier carried in a received downlink data notification message sent by an S-GW, a quality of service class identifier QCI to which the downlink data belongs, and determine the service type information according to the QCI; or

determine the service type information according to a received downlink data notification message sent by an S-GW, where the downlink data notification message carries the service type information.

With reference to the first possible implementation manner of the third aspect, in a third possible implementation manner, the network information includes the service type information, and the network side device is a single radio controller SRC;

the acquiring unit is further configured to determine the service type information according to a received second paging message sent by a mobility management node or an access network device, where the second paging message carries the service type information; and

the sending unit is further configured to add the target network indication information to the first paging message, and send the first paging message to the UE by using the access network device.

With reference to the first possible implementation manner of the third aspect, in a fourth possible implementation manner, the network information further includes activation indication information that is used to indicate whether idle state signaling reduction ISR of the UE is activated, and the network side device is a single radio controller SRC;

the acquiring unit is further configured to determine the activation indication information according to a received second paging message sent by a mobility management node or an access network device, and determine the target network indication information according to the service type information and the activation indication information, where the second paging message carries the activation indication information; and

the sending unit is further configured to add the target network indication information to the first paging message, and send the first paging message to the UE by using the access network device.

With reference to the first possible implementation manner of the third aspect, in a fifth possible implementation manner, the network information includes the service type information, and the network side device is an access network device; and

the acquiring unit is further configured to determine the service type information according to a received second paging message sent by a mobility management node or an SRC, where the second paging message carries the service type information.

With reference to the third aspect, in a sixth possible implementation manner, the target network indication information includes:

network standard indication information; or

network standard indication information and frequency indication information; or

network standard indication information and cell indication information.

According to a fourth aspect, user equipment includes:

a receiving unit, configured to receive a paging message that is sent by a network side device and that carries target network indication information; and

a processing unit, configured to determine a cell according to the target network indication information, and initiate a service request or respond to paging in the determined cell.

With reference to the fourth aspect, in a first possible implementation manner, the target network indication information includes network standard indication information; and

the processing unit is further configured to: if the processing unit determines that idle state signaling reduction ISR is activated and that a first network standard indicated by the network standard indication information is different from a second network standard used when the user equipment UE camps in an idle state and when the UE receives the paging message, select a first cell that is of the first network standard and whose signal quality meets a preset stipulation; and if the first cell is a cell in a location area with which the UE is registered, initiate the service request or respond to the paging in the first cell; or

if the processing unit determines that ISR is activated and that a first network standard indicated by the network standard indication information is different from a second network standard used when the UE camps in an idle state and when the UE receives the paging message, and if signal quality of any cell of the first network standard does not meet a preset stipulation, initiate the service request or respond to the paging in a cell of the second network standard used when the UE camps in the idle state and when the UE receives the paging message; or

if the processing unit determines that ISR is activated and that a first network standard indicated by the network standard indication information is different from a second network standard used when the UE camps in an idle state and when the UE receives the paging message, select a first cell that is of the first network standard and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processing unit determines that ISR is activated and that a first network standard indicated by the network standard indication information is different from a second network standard used when the UE camps in an idle state and when the UE receives the paging message, select the N^{th} cell that is of the first network standard and whose signal quality meets a preset stipulation; if the N^{th} cell is not a cell in a location area with which the UE is registered, select the (N+1)^{th} cell that is of the first network standard and whose signal quality meets the preset stipulation; and if the (N+1)^{th} cell is a cell in the location area with which the UE is registered, initiate the service request or respond to the paging in the (N+1)^{th} cell, where N is an integer, 1≦N≦M, and a quantity of cells that are of the first network standard and whose signal quality meets the preset stipulation is M; or

if the processing unit determines that ISR is activated and that a first network standard indicated by the network standard indication information is different from a second network standard used when the UE camps in an idle state and when the UE receives the paging message, and if none of cells that are of the first network standard and whose signal quality meets a preset stipulation is a cell in a location area with which the UE is registered, initiate the service request or respond to the paging in a cell of the second network standard used when the UE camps in the idle state and when the UE receives the paging message.

With reference to the fourth aspect, in a second possible implementation manner, the target network indication information includes network standard indication information; and

the processing unit is further configured to: if the processing unit determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

With reference to the fourth aspect, in a third possible implementation manner, the target network indication information includes network standard indication information and frequency indication information; and

the processing unit is further configured to: if the processing unit determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is a cell in a location area with which the UE is registered, initiate the service request or respond to the paging in the first cell; or

if the processing unit determines that ISR is activated and that a first network standard indicated by the network standard indication information is different from a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processing unit determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processing unit determines that ISR is activated and that a first network standard indicated by the network standard indication information is different from a second network standard used when the UE camps in an idle state and when the UE receives the paging message, select the I^{th} cell that is of the first network standard, that is of a frequency indicated by the frequency indication information, and whose signal quality meets a preset stipulation; if the I^{th} cell is not a cell in a location area with which the UE is registered, select the (I+1)^{th} cell that is of the frequency and whose signal quality meets the preset stipulation; and if the (I+1)^{th} cell is a cell in the location area with which the UE is registered, initiate the service request or respond to the paging in the (I+1)^{th} cell, where I is an integer, 1≦I≦J, and a quantity of cells that are of the frequency and whose signal quality meets the preset stipulation is J; or

if the processing unit determines that ISR is activated and that a first network standard indicated by the network standard indication information is different from a second network standard used when the UE camps in an idle state and when the UE receives the paging message, and if none of cells that are of the first network standard, that are of a frequency indicated by the frequency indication information, and whose signal quality meets a preset stipulation is a cell in a location area with which the UE is registered, initiate the service request or respond to the paging in a cell of the second network standard used when the UE camps in the idle state and when the UE receives the paging message.

With reference to the fourth aspect, in a fourth possible implementation manner, the target network indication information includes network standard indication information and frequency indication information; and

the processing unit is further configured to: if the processing unit determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is a cell in a location area with which the UE is registered, initiate the service request or respond to the paging in the first cell; or

if the processing unit determines that a first network standard indicated by the network standard indication information is the same as a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processing unit determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processing unit determines that a first network standard indicated by the network standard indication information is the same as a second network standard used when the UE camps in an idle state and when the UE receives the paging message, select the R^{th} cell that is of a frequency indicated by the frequency indication information and whose signal quality meets a preset stipulation; if the R^{th} cell is not a cell in a location area with which the UE is registered, select the (R+1)^{th} cell that is of the frequency and whose signal quality meets the preset stipulation; and if the (R+1)^{th} cell is a cell in the location area with which the UE is registered, initiate the service request or respond to the paging in the (R+1)^{th} cell, where R is an integer, 1≦R≦S, and a quantity of cells that are of the frequency and whose signal quality meets the preset stipulation is S.

With reference to the fourth aspect, in a fifth possible implementation manner, the target network indication information includes network standard indication information and cell indication information; and

the processing unit is further configured to: if the processing unit determines that: ISR is activated, a first network standard indicated by the network standard indication information is different from a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processing unit determines that ISR is activated and that a first network standard indicated by the network standard indication information is different from a second network standard used when the UE camps in an idle state and when the UE receives the paging message, and if signal quality of any first cell indicated by the cell indication information does not meet a preset stipulation, initiate the service request or respond to the paging in a cell of the second network standard used when the UE camps in the idle state and when the UE receives the paging message; or

if the processing unit determines that: ISR is activated, a first network standard indicated by the network standard indication information is different from a second network standard used when the UE camps in an idle state and when the UE receives the paging message, and a first cell indicated by the cell indication information is not a cell in a location area with which the UE is registered, initiate the service request or respond to the paging in a cell of the second network standard used when the UE camps in the idle state and when the UE receives the paging message.

With reference to the fourth aspect, in a sixth possible implementation manner, the target network indication information includes network standard indication information and cell indication information; and

the processing unit is further configured to: if the processing unit determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

With reference to the fourth aspect, in a seventh possible implementation manner, the target network indication information includes network standard indication information and cell indication information; and

the processing unit is further configured to: if the processing unit determines that a first network standard indicated by the network standard indication information is the same as a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processing unit determines that a first network standard indicated by the network standard indication information is the same as a second network standard used when the UE camps in an idle state and when the UE receives the paging message, and if signal quality of a first cell indicated by the cell indication information does not meet a preset stipulation, initiate the service request or respond to the paging in a cell of the second network standard used when the UE camps in the idle state and when the UE receives the paging message; or

if the processing unit determines that a first network standard indicated by the network standard indication information is the same as a second network standard used when the UE camps in an idle state and when the UE receives the paging message, and if a first cell indicated by the cell indication information is not a cell in a location area with which the UE is registered, initiate the service request or respond to the paging in a cell of the second network standard used when the UE camps in the idle state and when the UE receives the paging message.

According to a fifth aspect, an embodiment of the present invention provides a network side device, including:

a processor, configured to acquire network information and determine target network indication information according to the network information; and

a transmitter, connected to the processor and configured to add the target network indication information to a first paging message, and send the first paging message to user equipment UE, so that the UE determines a cell according to the target network indication information, and initiates a service request or responds to paging in the determined cell.

With reference to the fifth aspect, in a first possible implementation manner, the network information includes at least one of the following:

service type information of downlink data that triggers the paging and information about a network resource situation of an access network.

With reference to the first possible implementation manner of the fifth aspect, in a second possible implementation manner, the network information includes the service type information, and the network side device is a mobility management node; and

the processor is further configured to determine, according to a bearer identifier carried in a received downlink data notification message sent by a serving gateway S-GW, an access point name APN to which the downlink data belongs, and determine the service type information according to the APN; or

determine, according to a bearer identifier carried in a received downlink data notification message sent by an S-GW, a quality of service class identifier QCI to which the downlink data belongs, and determine the service type information according to the QCI; or

determine the service type information according to a received downlink data notification message sent by an S-GW, where the downlink data notification message carries the service type information.

With reference to the first possible implementation manner of the fifth aspect, in a third possible implementation manner, the network information includes the service type information, and the network side device is a single radio controller SRC;

the processor is further configured to determine the service type information according to a received second paging message sent by a mobility management node or an access network device, where the second paging message carries the service type information; and

the transmitter is further configured to add the target network indication information to the first paging message, and send the first paging message to the UE by using the access network device.

With reference to the first possible implementation manner of the fifth aspect, in a fourth possible implementation manner, the network information further includes activation indication information that is used to indicate whether idle state signaling reduction ISR of the UE is activated, and the network side device is a single radio controller SRC;

the processor is further configured to determine the activation indication information according to a received second paging message sent by a mobility management node or an access network device, and determine the target network indication information according to the service type information and the activation indication information, where the second paging message carries the activation indication information; and

the transmitter is further configured to add the target network indication information to the first paging message, and send the first paging message to the UE by using the access network device.

With reference to the first possible implementation manner of the fifth aspect, in a fifth possible implementation manner, the network information includes the service type information, and the network side device is an access network device; and

the processor is further configured to determine the service type information according to a received second paging message sent by a mobility management node or an SRC, where the second paging message carries the service type information.

With reference to the fifth aspect, in a sixth possible implementation manner, the target network indication information includes:

network standard indication information; or

network standard indication information and frequency indication information; or

network standard indication information and cell indication information.

According to a sixth aspect, an embodiment of the present invention provides user equipment, including:

a receiver, configured to receive a paging message that is sent by a network side device and that carries target network indication information; and

a processor, configured to determine a cell according to the target network indication information, and initiate a service request or respond to paging in the determined cell.

With reference to the sixth aspect, in a first possible implementation manner, the target network indication information includes network standard indication information; and

the processor is further configured to: if the processor determines that idle state signaling reduction ISR is activated and that a first network standard indicated by the network standard indication information is different from a second network standard used when the user equipment UE camps in an idle state and when the UE receives the paging message, select a first cell that is of the first network standard and whose signal quality meets a preset stipulation; and if the first cell is a cell in a location area with which the UE is registered, initiate the service request or respond to the paging in the first cell; or

if the processor determines that ISR is activated and that a first network standard indicated by the network standard indication information is different from a second network standard used when the UE camps in an idle state and when the UE receives the paging message, and if signal quality of any cell of the first network standard does not meet a preset stipulation, initiate the service request or respond to the paging in a cell of the second network standard used when the UE camps in the idle state and when the UE receives the paging message; or

if the processor determines that ISR is activated and that a first network standard indicated by the network standard indication information is different from a second network standard used when the UE camps in an idle state and when the UE receives the paging message, select a first cell that is of the first network standard and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processor determines that ISR is activated and that a first network standard indicated by the network standard indication information is different from a second network standard used when the UE camps in an idle state and when the UE receives the paging message, select the N^{th} cell that is of the first network standard and whose signal quality meets a preset stipulation; if the N^{th} cell is not a cell in a location area with which the UE is registered, select the (N+1)^{th} cell that is of the first network standard and whose signal quality meets the preset stipulation; and if the (N+1)^{th} cell is a cell in the location area with which the UE is registered, initiate the service request or respond to the paging in the (N+1)^{th} cell, where N is an integer, 1≦N≦M, and a quantity of cells that are of the first network standard and whose signal quality meets the preset stipulation is M; or

if the processor determines that ISR is activated and that a first network standard indicated by the network standard indication information is different from a second network standard used when the UE camps in an idle state and when the UE receives the paging message, and if none of cells that are of the first network standard and whose signal quality meets a preset stipulation is a cell in a location area with which the UE is registered, initiate the service request or respond to the paging in a cell of the second network standard used when the UE camps in the idle state and when the UE receives the paging message.

In a second possible implementation manner, the target network indication information includes network standard indication information; and

the processor is further configured to: if the processor determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

With reference to the sixth aspect, in a third possible implementation manner, the target network indication information includes network standard indication information and frequency indication information; and

the processor is further configured to: if the processor determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is a cell in a location area with which the UE is registered, initiate the service request or respond to the paging in the first cell; or

if the processor determines that ISR is activated and that a first network standard indicated by the network standard indication information is different from a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processor determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processor determines that ISR is activated and that a first network standard indicated by the network standard indication information is different from a second network standard used when the UE camps in an idle state and when the UE receives the paging message, select the I^{th} cell that is of the first network standard, that is of a frequency indicated by the frequency indication information, and whose signal quality meets a preset stipulation; if the I^{th} cell is not a cell in a location area with which the UE is registered, select the (I+1)^{th} cell that is of the frequency and whose signal quality meets the preset stipulation; and if the (I+1)^{th} cell is a cell in the location area with which the UE is registered, initiate the service request or respond to the paging in the (I+1)^{th} cell, where I is an integer, 1≦I≦J, and a quantity of cells that are of the frequency and whose signal quality meets the preset stipulation is J; or

if the processor determines that ISR is activated and that a first network standard indicated by the network standard indication information is different from a second network standard used when the UE camps in an idle state and when the UE receives the paging message, and if none of cells that are of the first network standard, that are of a frequency indicated by the frequency indication information, and whose signal quality meets a preset stipulation is a cell in a location area with which the UE is registered, initiate the service request or respond to the paging in a cell of the second network standard used when the UE camps in the idle state and when the UE receives the paging message.

With reference to the sixth aspect, in a fourth possible implementation manner, the target network indication information includes network standard indication information and frequency indication information; and

the processor is further configured to: if the processor determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is a cell in a location area with which the UE is registered, initiate the service request or respond to the paging in the first cell; or

if the processor determines that a first network standard indicated by the network standard indication information is the same as a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processor determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processor determines that a first network standard indicated by the network standard indication information is the same as a second network standard used when the UE camps in an idle state and when the UE receives the paging message, select the R^{th} cell that is of a frequency indicated by the frequency indication information and whose signal quality meets a preset stipulation; if the R^{th} cell is not a cell in a location area with which the UE is registered, select the (R+1)^{th} cell that is of the frequency and whose signal quality meets a preset stipulation; and if the (R+1)^{th} cell is a cell in the location area with which the UE is registered, initiate the service request or respond to the paging in the (R+1)^{th} cell, where R is an integer, 1≦R≦S, and a quantity of cells that are of the frequency and whose signal quality meets the preset stipulation is S.

With reference to the sixth aspect, in a fifth possible implementation manner, the target network indication information includes network standard indication information and cell indication information; and

the processor is further configured to: if the processor determines that: ISR is activated, a first network standard indicated by the network standard indication information is different from a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processor determines that ISR is activated and that a first network standard indicated by the network standard indication information is different from a second network standard used when the UE camps in an idle state and when the UE receives the paging message, and if signal quality of any first cell indicated by the cell indication information does not meet a preset stipulation, initiate the service request or respond to the paging in a cell of the second network standard used when the UE camps in the idle state and when the UE receives the paging message; or

if the processor determines that: ISR is activated, a first network standard indicated by the network standard indication information is different from a second network standard used when the UE camps in an idle state and when the UE receives the paging message, and a first cell indicated by the cell indication information is not a cell in a location area with which the UE is registered, initiate the service request or respond to the paging in a cell of the second network standard used when the UE camps in the idle state and when the UE receives the paging message.

With reference to the sixth aspect, in a sixth possible implementation manner, the target network indication information includes network standard indication information and cell indication information; and

the processor is further configured to: if the processor determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

With reference to the sixth aspect, in a seventh possible implementation manner, the target network indication information includes network standard indication information and cell indication information; and

the processor is further configured to: if the processor determines that: a first network standard indicated by the network standard indication information is the same as a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processor determines that a first network standard indicated by the network standard indication information is the same as a second network standard used when the UE camps in an idle state and when the UE receives the paging message, and if signal quality of a first cell indicated by the cell indication information does not meet a preset stipulation, initiate the service request or respond to the paging in a cell of the second network standard used when the UE camps in the idle state and when the UE receives the paging message; or

if the processor determines that a first network standard indicated by the network standard indication information is the same as a second network standard used when the UE camps in an idle state and when the UE receives the paging message, and if a first cell indicated by the cell indication information is not a cell in a location area with which the UE is registered, initiate the service request or respond to the paging in a cell of the second network standard used when the UE camps in the idle state and when the UE receives the paging message.

According to the paging method and device in a wireless communications system provided in the embodiments of the present invention, a network side device acquires network information, determines target network indication information according to the network information, and adds the target network indication information to a paging message and sends the paging message to user equipment UE. The target network indication information is carried in the paging message, so that the UE selects a cell according to the target network indication information, and initiates a service request or responds to paging in the selected cell. This avoids restriction, on network resource allocation, caused by that the UE can only wait for paging and respond in a cell of a network standard used when the UE camps in an idle state and when the UE receives the paging message, thereby improving a paging effect.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a flowchart of a first paging method in a wireless communications system according to an embodiment of the present invention;

FIG. 2 is a schematic diagram of a network architecture according to an embodiment of the present invention;

FIG. 3 is a schematic diagram of another network architecture according to an embodiment of the present invention;

FIG. 4 is a flowchart of a second paging method in a wireless communications system according to an embodiment of the present invention;

FIG. 5 is a schematic structural diagram of a first network side device according to an embodiment of the present invention;

FIG. 6 is a schematic structural diagram of first user equipment according to an embodiment of the present invention;

FIG. 7 is a schematic structural diagram of a second network side device according to an embodiment of the present invention; and

FIG. 8 is a schematic structural diagram of second user equipment according to an embodiment of the present invention.

### DETAILED DESCRIPTION OF ILLUSTRATIVE EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

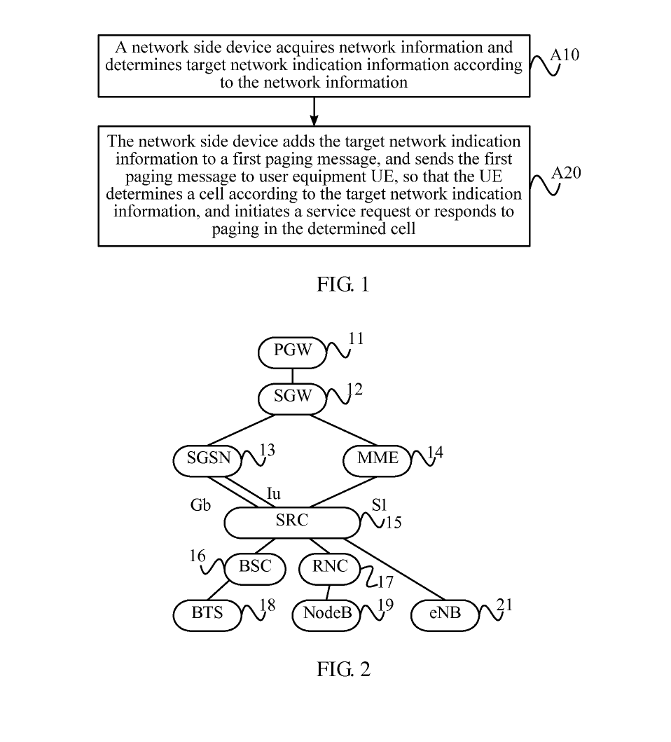

FIG. 1 is a flowchart of a first paging method in a wireless communications system according to an embodiment of the present invention. As shown in FIG. 1, the paging method in a wireless communications system provided in this embodiment is specifically applied to a paging process of a wireless communications system. This wireless communications system is an application scenario in which at least two network standards, for example, an LTE network and a 2G/3G network coexist. The 2G network includes a GSM (Global System for Mobile Communications) network, a TDMA (Time Division Multiple Access) network, and the like. The 3G network includes a WCDMA (Wideband Code Division Multiple Access) network, a TD-SCDMA (Time Division-Synchronous Code Division Multiple Access) network, and the like. Network elements in the LTE network specifically include a P-GW (packet data network gateway), an S-GW (Serving Gateway), an MME (mobility management entity), and an eNB (evolved NodeB). Network elements in the 2G network specifically include a P-GW, an S-GW, an SGSN (serving GPRS support node), a BTS (base transceiver station), and a BSC (base station controller). Network elements in the 3G network specifically include a P-GW, an S-GW, an SGSN, a Node B (NodeB), and an RNC (Radio Network Controller, radio network controller). For ease of description, the following embodiments all use the application scenario in which the LTE network and the 2G/3G network coexist for description; however, the present invention is not limited thereto.

The paging method in a wireless communications system provided in this embodiment specifically includes:

Step A10: A network side device acquires network information and determines target network indication information according to the network information.

Step A20: The network side device adds the target network indication information to a first paging message, and sends the first paging message to user equipment UE, so that the UE determines a cell according to the target network indication information, and initiates a service request or responds to paging in the determined cell.

Specifically, the network side device may be a mobility management node, for example, the MME in the LTE network or the SGSN in the 2G/3G network. The network side device may also be an access network device, for example, the eNB in the LTE network, the BSC in the 2G network, or the RNC in the 3G network. The network side device may also be a single radio controller SRC added in the wireless communications system.

In a network architecture, an SRC may be disposed between a mobility management node and an access network device. Interfaces between the SRC and access network devices of different network standards in an area and interfaces between the SRC and mobility management nodes of different network standards in this area are disposed on the SRC. As shown in FIG. 2, a P-GW11, an S-GW12, an SGSN13, an MME14, an SRC15, a BSC16, an RNC17, a BTS18, a Node B19, and an eNB21 are disposed in this network architecture. An interface between the SRC15 and the SGSN13 is Gb/Iu, and an interface between the SRC15 and the MME14 is S1. A quantity of Gb or Iu or S1 interfaces may be one or more.

In another network architecture, an SRC does not directly connect to a mobility management node. Interfaces between the SRC and access network devices of different network standards in this area may be disposed on the SRC. The access network devices may forward, to the SRC, signaling sent by the mobility management node. As shown in FIG. 3, a P-GW11, an S-GW12, an SGSN13, an MME14, an SRC15, a BSC16, an RNC17, a BTS18, a Node B19, and an eNB21 are disposed in this network architecture. An interface between the SGSN13 and the BSC16 is Gb, an interface between the SGSN13 and the RNC17 is Iu, and an interface between the MME14 and the eNB21 is S1. The SRC15 directly interacts with the BSC16, the RNC17, and the eNB21. A quantity of BSC16s, RNC17s, or eNB21s that are connected to the SRC15 may be one or more.

After the UE switches to an idle state, downlink data of the UE arrives at the P-GW, which triggers the paging process. The network information may specifically include one or more pieces of service type information of the downlink data that triggers the paging and information about a network resource situation of an access network. The network information may further include other information, such as activation indication information that is used to indicate whether idle mode signaling reduction (Idle State Signaling Reduction, ISR for short) of the UE is activated.

The network side device acquires the network information and determines the target network indication information according to the network information, where the target network indication information includes network standard indication information and frequency indication information and/or cell indication information. The network standard indication information is used to indicate a network standard, the frequency indication information is used to indicate a frequency, and the cell indication information is used to indicate a cell. For example, the network side device may select a network standard suitable for a service according to a service type of the downlink data; the network side device may further determine a network standard and a frequency and/or a cell according to a network status of a current access network; the network side device may further determine, according to the activation indication information, whether the ISR of the UE is activated, and refer to an ISR state of the UE in the foregoing process of determining the target network indication information, so as to improve correctness of determining the target network indication information. The network standard indicated by the target network indication information may be the same as or different from a network standard used when the UE camps in the idle state and when the UE receives the paging message. The paging message sent by the network side device to the UE carries the target network indication information, so that the UE selects a cell according to the target network indication information. If the network standard and the cell that are selected by the UE are different from a network standard and a cell that are used when the UE camps in the idle state and when the UE receives the paging message, the UE does not respond to the paging or initiate the service request in a cell of the network standard used when the UE camps in the idle state and when the UE receives the paging message; instead, the UE responds to the paging or initiates the service request in a cell of the selected network standard.

According to the paging method in a wireless communications system provided in this embodiment, a network side device acquires network information, determines target network indication information according to the network information, and adds the target network indication information to a paging message and sends the paging message to user equipment UE. The target network indication information is carried in the paging message, so that the UE selects a cell according to the target network indication information, and initiates a service request or responds to paging in the selected cell. This avoids restriction, on network resource allocation, caused by that the UE can only wait for paging and respond in a cell of a network standard used when the UE camps in an idle state and when the UE receives the paging message, thereby improving a paging effect.

In this embodiment, preferably, the network information includes at least one of the following:

the service type information of the downlink data that triggers the paging and the information about the network resource situation of the access network.

In this embodiment, the network information may further include the activation indication information that is used to indicate whether the ISR of the UE is activated.

In this embodiment, the network information includes the service type information, and the network side device is a mobility management node.

That a network side device acquires network information in step A10 includes:

determining, by the mobility management node according to a bearer identifier carried in a received downlink data notification message sent by a serving gateway S-GW, an access point name APN to which the downlink data belongs, and determining the service type information according to the APN; or

determining, by the mobility management node according to a bearer identifier carried in a received downlink data notification message sent by an S-GW, a quality of service class identifier QCI to which the downlink data belongs, and determining the service type information according to the QCI; or

determining, by the mobility management node, the service type information according to a received downlink data notification message sent by an S-GW, where the downlink data notification message carries the service type information.

That the network side device adds the target network indication information to a first paging message, and sends the first paging message to user equipment UE in step A20 includes:

adding, by the mobility management node, the target network indication information to the first paging message, and sending the first paging message to the UE by using the access network device.

Specifically, the network side device is a mobility management node, for example, the MME in the LTE network or the SGSN in the 2G/3G network. The downlink data of the UE arrives at the P-GW, and the P-GW sends the downlink data to the S-GW. If the ISR of the UE is activated, the S-GW separately sends the downlink data notification message to the MME and the SGSN. The downlink data notification message may carry the bearer identifier, and the MME or the SGSN may determine, according to the bearer identifier, a service flow that triggers the paging, that is, the APN to which the downlink data belongs, and may determine a service type of the downlink data according to the APN. The MME or the SGSN may further determine, according to the bearer identifier carried in the downlink data notification message, the QCI to which the downlink data belongs, and may further determine the service type of the downlink data according to the QCI. The S-GW may further directly add the service type information to the downlink data notification message, where the service type information may specifically be carried in a GTP (GPRS tunneling protocol) header of a data packet sent by the P-GW to the S-GW, or be obtained by mapping a DSCP (differentiated services code point) value in a data packet.

The mobility management node may select, according to the service type of the downlink data, a network standard suitable for transmission of the downlink data; and use network standard indication information that indicates the network standard as the target network indication information, add the target network indication information to the paging message, and send the paging message to the access network device such as the eNB/BSC/RNC. The mobility management node may further determine a suitable network standard and frequency and/or cell according to the information, reported by the access network device, about the network resource situation of the access network. The network standard indicated by the target network indication information may be the same as or different from the network standard used when the UE camps in the idle state and when the UE receives the paging message.

The mobility management node may further learn whether the ISR of the UE is activated. If the ISR of the UE is activated, the network standard determined by the mobility management node may be different from the network standard used when the UE camps in the idle state and when the UE receives the paging message. If the ISR of the UE is not activated, the network standard determined by the mobility management node should be the same as the network standard used when the UE camps in the idle state and when the UE receives the paging message.

In this embodiment, the network information includes the service type information, and the network side device is a single radio controller SRC.

That a network side device acquires network information in step A10 includes:

determining, by the SRC, the service type information according to a received paging message sent by a mobility management node or an access network device, where the paging message carries the service type information.

That the network side device adds the target network indication information to a first paging message, and sends the first paging message to user equipment UE in step A20 includes:

adding, by the SRC, the target network indication information to the first paging message, and sending the first paging message to the UE by using the access network device.

Specifically, the network side device is an SRC. In the network architecture shown in FIG. 2, the SRC may receive the paging message sent by the mobility management node. In the network architecture shown in FIG. 3, the SRC may receive the paging message forwarded by the access network device. For a manner of determining the service type of the downlink data by the mobility management node, reference may specifically be made to the description of the embodiment in which the network side device is a mobility management node, which is not described herein again. The SRC may select, according to the service type of the downlink data, a network standard suitable for transmission of the downlink data; and use network standard indication information that indicates the network standard as the target network indication information, add the target network indication information to the paging message, and send the paging message to the access network device. The SRC may determine a suitable network standard and frequency and/or cell according to the information, reported by the access network device, about the network resource situation of the access network. The network standard indicated by the target network indication information may be the same as or different from a network standard used when the UE camps in the idle state and when the UE receives the paging message. The SRC may further determine the target network indication information according to one or more principles of load or of balance between user systems.

In this embodiment, the network information may further include the activation indication information that is used to indicate whether the idle state signaling reduction ISR of the UE is activated, and the network side device is a single radio controller SRC.

That a network side device acquires network information and determines target network indication information according to the network information in step A10 includes:

determining, by the SRC, the activation indication information according to a received second paging message sent by a mobility management node or an access network device, and determining the target network indication information according to the service type information and the activation indication information, where the second paging message carries the activation indication information.

That the network side device adds the target network indication information to a first paging message, and sends the first paging message to user equipment UE in step A20 includes:

adding, by the SRC, the target network indication information to the first paging message, and sending the first paging message to the UE by using the access network device.

Specifically, in the network architecture shown in FIG. 2, the mobility management node may add the activation indication information to the paging message, and send the paging message to the SRC; or, in the network architecture shown in FIG. 3, the mobility management node sends the paging message to the access network device, and after receiving the paging message, the access network device forwards the paging message to the SRC instead of performing paging on the UE. The SRC determines the target network indication information according to the service type information and the activation indication information, adds the target network indication information to the paging message, and sends the paging message to the access network device; the access network device then sends the paging message to the UE.

In this embodiment, the network information includes the service type information, and the network side device is an access network device.

That a network side device acquires network information in step A10 includes:

determining, by the access network device, the service type information according to a received second paging message sent by a mobility management node or an SRC, where the second paging message carries the service type information.

That the network side device adds the target network indication information to a first paging message, and sends the first paging message to user equipment UE in step A20 includes:

adding, by the access network device, the target network indication information to the first paging message, and sending the first paging message to the UE.

Specifically, the network side device is an access network device, for example, the eNB in the LTE network, the BSC in the 2G network, or the RNC in the 3G network. In a network architecture with no SRC disposed, the access network device receives the paging message sent by the mobility management node, where the paging message carries the service type information. For a manner of determining a service type of the downlink data by the mobility management node, reference may specifically be made to the description of the embodiment in which the network side device is a mobility management node, which is not described herein again. In a network architecture with an SRC disposed, the access network device may receive the paging message sent by the SRC, where the paging message carries the service type information. The access network device may select, according to the service type of the downlink data, a network standard suitable for transmission of the downlink data; and use network standard indication information that indicates the network standard as the target network indication information, add the target network indication information to the paging message, and send the paging message to the UE. The access network device may perform detection on the network resource situation of the access network, so as to acquire the information about the network resource situation of the access network. The access network device may further determine a suitable network standard and frequency and/or cell according to the information about the network resource situation of the access network. The access network device may further add the activation indication information to the paging message received from the mobility management node or the SRC. In the foregoing process of determining the target network indication information, the access network device refers to whether the ISR of the UE is activated, so as to improve correctness of determining the target network indication information.

In this embodiment, the target network indication information includes network standard indication information, or network standard indication information and frequency indication information, or network standard indication information and cell indication information.

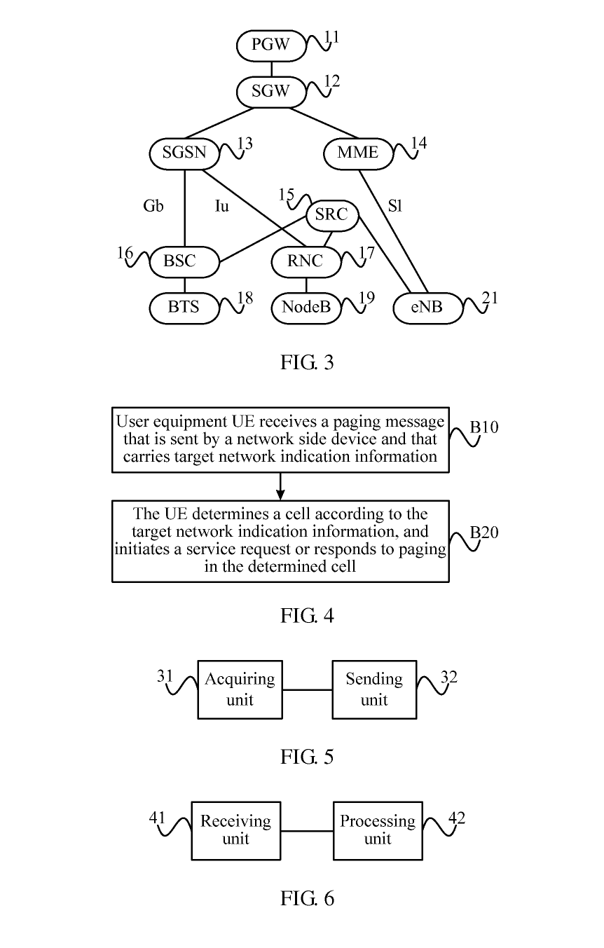

FIG. 4 is a flowchart of a second paging method in a wireless communications system according to an embodiment of the present invention. As shown in FIG. 4, the paging method in a wireless communications system provided in this embodiment may specifically be implemented in cooperation with a paging method, applied to a network side device, in a wireless communication system, and a specific implementation process is not described herein again. The paging method in a wireless communications system provided in this embodiment specifically includes:

Step B10: User equipment UE receives a paging message that is sent by a network side device and that carries target network indication information.

Step B20: The UE determines a cell according to the target network indication information, and initiates a service request or responds to paging in the determined cell.

According to the paging method in a wireless communications system provided in this embodiment, UE receives a paging message that is sent by a network side device and that carries target network indication information, determines a cell according to the target network indication information, and initiates a service request or responds to paging in the determined cell. The target network indication information is carried in the paging message, so that the UE selects the cell according to the target network indication information, and initiates the service request or responds to the paging in the selected cell. This avoids restriction, on network resource allocation, caused by that the UE can only wait for paging and respond in a cell of a network standard used when the UE camps in an idle state and when the UE receives the paging message, thereby improving a paging effect.

In an actual application process, the UE may select a cell according to factors such as whether ISR of the UE is activated, the target network indication information in the received paging message, and a location area with which the UE is registered. A result of selection may vary with the foregoing factors, which is described in the following implementation manners.

In this embodiment, the target network indication information includes network standard indication information.

That the UE determines a cell according to the target network indication information, and initiates a service request or responds to paging in the determined cell in step B20 includes:

if the UE determines that idle state signaling reduction ISR is activated and that a first network standard indicated by the network standard indication information is different from a second network standard used when the UE camps in an idle state and when the UE receives the paging message, selecting a first cell that is of the first network standard and whose signal quality meets a preset stipulation; and if the first cell is a cell in a location area with which the UE is registered, initiating the service request or responding to the paging in the first cell; or

if the UE determines that ISR is activated and that a first network standard indicated by the network standard indication information is different from a second network standard used when the UE camps in an idle state and when the UE receives the paging message, and if signal quality of any cell of the first network standard does not meet a preset stipulation, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting a first cell that is of the first network standard and whose signal quality meets a preset stipulation; and if the first cell is not a cell in a location area with which the UE is registered, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting the N^{th} cell that is of the first network standard and whose signal quality meets a preset stipulation; if the N^{th} cell is not a cell in a location area with which the UE is registered, selecting the (N+1)^{th} cell that is of the first network standard and whose signal quality meets the preset stipulation; and if the (N+1)^{th} cell is a cell in the location area with which the UE is registered, initiating the service request or responding to the paging in the (N+1)^{th} cell, where N is an integer, 1≦N≦M, and a quantity of cells that are of the first network standard and whose signal quality meets the preset stipulation is M; or

if the UE determines that ISR is activated and that a first network standard indicated by the network standard indication information is different from a second network standard used when the UE camps in an idle state and when the UE receives the paging message, and if none of cells that are of the first network standard and whose signal quality meets a preset stipulation is a cell in a location area with which the UE is registered, initiating the service request or responding to the paging in a cell of the second network standard used when the UE camps in the idle state and when the UE receives the paging message.

Specifically, if the ISR of the UE is activated, the second network standard is used when the UE camps in the idle state and when the UE receives the paging message, and the network standard indication information in the paging message received by the UE indicates the first network standard that is different from the second network standard, the UE selects a cell that is of the first network standard and whose signal quality meets a preset stipulation. In this process, selection may be performed according to a frequency and location information that are of a history cell reserved by the UE. A priority of a frequency and signal quality of a cell may be historical records, and may also be acquired in real time. When there are multiple cells whose signal quality meets the preset stipulation, a cell whose signal quality is the best may be selected. If the cell is a cell in the location area with which the UE is registered, the UE monitors and responds to the paging or proactively initiates the service request in the selected cell of the first network standard.

If the ISR of the UE is activated, the second network standard is used when the UE camps in the idle state and when the UE receives the paging message, and the network standard indication information in the paging message received by the UE indicates the first network standard that is different from the second network standard, the UE selects a cell that is of the first network standard and whose signal quality meets a preset stipulation. If signal quality of any cell of the first network standard does not meet the stipulation, the UE returns to the cell on which the UE originally camps to initiate the service request or respond to the paging. Alternatively, if the foregoing cell that is selected by the UE and whose signal quality meets the stipulation is not a cell in the location area with which the UE is registered, the UE may also return to the cell on which the UE originally camps to initiate the service request or respond to the paging.

The UE may further successively perform, according to signal quality in a descending order, determining on cells that are of the first network standard and whose signal quality meets the preset stipulation, until a cell in the location area with which the UE is registered is found.

If none of the cells that are of the first network standard and whose signal quality meets the preset stipulation is a cell in the location area with which the UE is registered, the UE returns to the cell on which the UE originally camps to initiate the service request or respond to the paging.

In this embodiment, the target network indication information includes network standard indication information.

That the UE determines a cell according to the target network indication information, and initiates a service request or responds to paging in the determined cell in step B20 includes:

if the UE determines that ISR is not activated and that a first network standard indicated by the network standard indication information is different from a second network standard used when the UE camps in an idle state and when the UE receives the paging message, initiating the service request or responding to the paging in a cell of the second network standard used when the UE camps in the idle state and when the UE receives the paging message.

Specifically, if the ISR of the UE is not activated, the second network standard is used when the UE camps in the idle state and when the UE receives the paging message, and the network standard indication information in the paging message received by the UE indicates the first network standard that is different from the second network standard, the UE returns to the cell, of the second network standard, on which the UE originally camps to initiate the service request or respond to the paging.

In this embodiment, the target network indication information includes network standard indication information and frequency indication information.

That the UE determines a cell according to the target network indication information, and initiates a service request or responds to paging in the determined cell in step B20 includes:

if the UE determines that ISR is activated and that a first network standard indicated by the network standard indication information is different from a second network standard used when the UE camps in an idle state and when the UE receives the paging message, selecting a first cell that is of the first network standard, that is of a frequency indicated by the frequency indication information, and whose signal quality meets a preset stipulation; and if the first cell is a cell in a location area with which the UE is registered, initiating the service request or responding to the paging in the first cell; or

if the UE determines that ISR is activated and that a first network standard indicated by the network standard indication information is different from a second network standard used when the UE camps in an idle state and when the UE receives the paging message, and if signal quality of any cell that is of the first network standard and that is of a frequency indicated by the frequency indication information does not meet a preset stipulation, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting a first cell that is of the first network standard, that is of a frequency indicated by the frequency indication information, and whose signal quality meets a preset stipulation; and if the first cell is not a cell in a location area with which the UE is registered, initiating the service request or responding to the paging in a cell of the second network standard used when the UE camps in the idle state and when the UE receives the paging message; or

if the UE determines that ISR is activated and that a first network standard indicated by the network standard indication information is different from a second network standard used when the UE camps in an idle state and when the UE receives the paging message, selecting the I^{th} cell that is of the first network standard, that is of a frequency indicated by the frequency indication information, and whose signal quality meets a preset stipulation; if the I^{th} cell is not a cell in a location area with which the UE is registered, selecting the (I+1)^{th} cell that is of the frequency and whose signal quality meets the preset stipulation; and if the (I+1)^{th} cell is a cell in the location area with which the UE is registered, initiating the service request or responding to the paging in the (I+1)^{th} cell, where I is an integer, 1≦I≦J, and a quantity of cells that are of the frequency and whose signal quality meets the preset stipulation is J; or

if the UE determines that ISR is activated and that a first network standard indicated by the network standard indication information is different from a second network standard used when the UE camps in an idle state and when the UE receives the paging message, and if none of cells that are of the first network standard, that are of a frequency indicated by the frequency indication information, and whose signal quality meets a preset stipulation is a cell in a location area with which the UE is registered, initiating the service request or responding to the paging in a cell of the second network standard used when the UE camps in the idle state and when the UE receives the paging message.

Specifically, if the ISR of the UE is activated, the second network standard is used when the UE camps in the idle state and when the UE receives the paging message, and the network standard indication information in the paging message received by the UE indicates the first network standard that is different from the second network standard, the UE selects a cell that is of the first network standard, that is of the frequency indicated by the frequency indication information, and whose signal quality meets the preset stipulation. In this process, selection may be performed according to a frequency and location information that are of a history cell reserved by the UE. Signal quality of a cell may be a historical record, and may also be acquired in real time. When there are multiple cells whose signal quality meets the preset stipulation, a cell whose signal quality is the best may be selected. If the cell is a cell in the location area with which the UE is registered, the UE monitors and responds to the paging or proactively initiates the service request in the selected cell of the first network standard.

If the ISR of the UE is activated, the second network standard is used when the UE camps in the idle state and when the UE receives the paging message, and the network standard indication information in the paging message received by the UE indicates the first network standard that is different from the second network standard, the UE selects a cell that is of the first network standard, that is of the frequency indicated by the frequency indication information, and whose signal quality meets the preset stipulation. If signal quality of any cell of the frequency does not meet the stipulation, the UE returns to the cell on which the UE originally camps to initiate the service request or respond to the paging. Alternatively, if the foregoing cell that is selected by the UE and whose signal quality meets the stipulation is not a cell in the location area with which the UE is registered, the UE may also return to the cell on which the UE originally camps to initiate the service request or respond to the paging.

The UE may further successively perform, according to signal quality in a descending order, determining on cells that are of the frequency and whose signal quality meets the preset stipulation, until a cell in the location area with which the UE is registered is found.

If none of the cells that are of the frequency and whose signal quality meets the preset stipulation is a cell in the location area with which the UE is registered, the UE returns to the cell on which the UE originally camps to initiate the service request or respond to the paging.

In this embodiment, the target network indication information includes network standard indication information and frequency indication information.

That the UE determines a cell according to the target network indication information, and initiates a service request or responds to paging in the determined cell in step B20 includes:

if the UE determines that a first network standard indicated by the network standard indication information is the same as a second network standard used when the UE camps in an idle state and when the UE receives the paging message, selecting a first cell that is of a frequency indicated by the frequency indication information and whose signal quality meets a preset stipulation; and if the first cell is a cell in a location area with which the UE is registered, initiating the service request or responding to the paging in the first cell; or

if the UE determines that a first network standard indicated by the network standard indication information is the same as a second network standard used when the UE camps in an idle state and when the UE receives the paging message, and if signal quality of any cell that is of the first network standard and that is of a frequency indicated by the frequency indication information does not meet a preset stipulation, initiating the service request or responding to the paging in a cell of the second network standard used when the UE camps in the idle state and when the UE receives the paging message; or

if the UE determines that a first network standard indicated by the network standard indication information is the same as a second network standard used when the UE camps in an idle state and when the UE receives the paging message, selecting a first cell that is of a frequency indicated by the frequency indication information and whose signal quality meets a preset stipulation; and if the first cell is not a cell in a location area with which the UE is registered, initiating the service request or responding to the paging in a cell of the second network standard used when the UE camps in the idle state and when the UE receives the paging message; or

if the UE determines that a first network standard indicated by the network standard indication information is the same as a second network standard used when the UE camps in an idle state and when the UE receives the paging message, selecting the R^{th} cell that is of a frequency indicated by the frequency indication information and whose signal quality meets a preset stipulation; if the R^{th} cell is not a cell in a location area with which the UE is registered, selecting the (R+1)^{th} cell that is of the frequency and whose signal quality meets the preset stipulation; and if the (R+1)^{th} cell is a cell in the location area with which the UE is registered, initiating the service request or responding to the paging in the (R+1)^{th} cell, where R is an integer, 1≦R≦S, and a quantity of cells that are of the frequency and whose signal quality meets the preset stipulation is S.

Specifically, if the network standard indicated by the network standard indication information in the paging message received by the UE is the same as the network standard used when the UE camps in the idle state and when the UE receives the paging message, the UE selects a cell that is of the network standard, that is of the frequency indicated by the frequency indication information, and whose signal quality meets the preset stipulation. In this process, selection may be performed according to a frequency and location information that are of a history cell reserved by the UE. Signal quality of a cell may be a historical record, and may also be acquired in real time. When there are multiple cells whose signal quality meets the preset stipulation, a cell whose signal quality is the best may be selected. If the cell is a cell in the location area with which the UE is registered, the UE monitors and responds to the paging or proactively initiates the service request in the selected cell.

If the network standard indicated by the network standard indication information in the paging message received by the UE is the same as the network standard used when the UE camps in the idle state and when the UE receives the paging message, the UE selects a cell that is of the network standard, that is of the frequency indicated by the frequency indication information, and whose signal quality meets the preset stipulation. If signal quality of any cell of the frequency does not meet the stipulation, the UE returns to the cell on which the UE originally camps to initiate the service request or respond to the paging. Alternatively, if the foregoing cell that is selected by the UE and whose signal quality meets the stipulation is not a cell in the location area with which the UE is registered, the UE may also return to the cell on which the UE originally camps to initiate the service request or respond to the paging.

The UE may further successively perform, according to signal quality in a descending order, determining on cells that are of the frequency and whose signal quality meets the preset stipulation, until a cell in the location area with which the UE is registered is found.

In this embodiment, the target network indication information includes network standard indication information and cell indication information.

That the UE determines a cell according to the target network indication information, and initiates a service request or responds to paging in the determined cell in step B20 includes:

if the UE determines that: ISR is activated, a first network standard indicated by the network standard indication information is different from a second network standard used when the UE camps in an idle state and when the UE receives the paging message, signal quality of a first cell indicated by the cell indication information meets a preset stipulation, and the first cell is a cell in a location area with which the UE is registered, initiating the service request or responding to the paging in the first cell; or

if the UE determines that ISR is activated and that a first network standard indicated by the network standard indication information is different from a second network standard used when the UE camps in an idle state and when the UE receives the paging message, and if signal quality of any first cell indicated by the cell indication information does not meet a preset stipulation, initiating the service request or responding to the paging in a cell of the second network standard used when the UE camps in the idle state and when the UE receives the paging message; or

if the UE determines that: ISR is activated, a first network standard indicated by the network standard indication information is different from a second network standard used when the UE camps in an idle state and when the UE receives the paging message, and a first cell indicated by the cell indication information is not a cell in a location area with which the UE is registered, initiating the service request or responding to the paging in a cell of the second network standard used when the UE camps in the idle state and when the UE receives the paging message.

Specifically, if the ISR of the UE is activated, the second network standard is used when the UE camps in the idle state and when the UE receives the paging message, the network standard indication information in the paging message received by the UE indicates the first network standard that is different from the second network standard, the cell indicated by the cell indication information is a cell on which the UE used to camp, and the signal quality of the cell meets a preset stipulation, the UE monitors and responds to the paging or proactively initiates the service request in the cell.

If the signal quality of the cell indicated by the cell indication information does not meet the preset stipulation or the cell is not a cell in the location area with which the UE is registered, the UE returns to the cell on which the UE originally camps to initiate the service request or respond to the paging.

In this embodiment, the target network indication information includes network standard indication information and cell indication information.

That the UE determines a cell according to the target network indication information, and initiates a service request or responds to paging in the determined cell in step B20 includes:

if the UE determines that ISR is not activated and that a first network standard indicated by the network standard indication information is different from a second network standard used when the UE camps in an idle state and when the UE receives the paging message, initiating the service request or responding to the paging in a cell of the second network standard used when the UE camps in the idle state and when the UE receives the paging message.

Specifically, if the ISR of the UE is not activated, the second network standard is used when the UE camps in the idle state and when the UE receives the paging message, and the network standard indication information in the paging message received by the UE indicates the first network standard that is different from the second network standard, the UE returns to the cell on which the UE originally camps to initiate the service request or respond to the paging.

In this embodiment, the target network indication information includes network standard indication information and cell indication information.

That the UE determines a cell according to the target network indication information, and initiates a service request or responds to paging in the determined cell in step B20 includes:

if the UE determines that a first network standard indicated by the network standard indication information is the same as a second network standard used when the UE camps in an idle state and when the UE receives the paging message, signal quality of a first cell indicated by the cell indication information meets a preset stipulation, and the first cell is a cell in a location area with which the UE is registered, initiating the service request or responding to the paging in the first cell; or

if the UE determines that a first network standard indicated by the network standard indication information is the same as a second network standard used when the UE camps in an idle state and when the UE receives the paging message, and if signal quality of a first cell indicated by the cell indication information does not meet a preset stipulation, initiating the service request or responding to the paging in a cell of the second network standard used when the UE camps in the idle state and when the UE receives the paging message; or

if the UE determines that a first network standard indicated by the network standard indication information is the same as a second network standard used when the UE camps in an idle state and when the UE receives the paging message, and if a first cell indicated by the cell indication information is not a cell in a location area with which the UE is registered, initiating the service request or responding to the paging in a cell of the second network standard used when the UE camps in the idle state and when the UE receives the paging message.

Specifically, if the network standard indicated by the network standard indication information in the paging message received by the UE is the same as the network standard used when the UE camps in the idle state and when the UE receives the paging message, the signal quality of the cell indicated by the cell indication information meets the preset stipulation, and the cell is a cell in the location area with which the UE is registered, the UE monitors and responds to the paging or proactively initiates the service request in the cell.

If the signal quality of the cell does not meet the preset stipulation or the cell is not a cell in the location area with which the UE is registered, the UE returns to the cell on which the UE originally camps to initiate the service request or respond to the paging.

FIG. 5 is a schematic structural diagram of a first network side device according to an embodiment of the present invention. As shown in FIG. 5, the network side device provided in this embodiment may specifically implement steps of a paging method, applied to a network side device and provided in any embodiment of the present invention, in a wireless communications system, and a specific implementation process is not described herein again.

The network side device provided in this embodiment specifically includes:

an acquiring unit 31, configured to acquire network information and determine target network indication information according to the network information; and

a sending unit 32, configured to add the target network indication information to a first paging message, and send the first paging message to user equipment UE, so that the UE determines a cell according to the target network indication information, and initiates a service request or responds to paging in the determined cell.

According to the network side device provided in this embodiment, an acquiring unit 31 acquires network information and determines target network indication information according to the network information; and a sending unit 32 adds the target network indication information to a paging message, and sends the paging message to user equipment UE. The target network indication information is carried in the paging message, so that the UE selects a cell according to the target network indication information, and initiates a service request or responds to paging in the selected cell. This avoids restriction, on network resource allocation, caused by that the UE can only wait for paging and respond in a cell of a network standard used when the UE camps in an idle state and when the UE receives the paging message, thereby improving a paging effect.

In this embodiment, the network information may include at least one of the following:

service type information of downlink data that triggers the paging and information about a network resource situation of an access network.

In this embodiment, the network information may further include activation indication information that is used to indicate whether ISR of the UE is activated.

In this embodiment, the network information includes the service type information, and the network side device is a mobility management node.

The acquiring unit 31 is further configured to determine, according to a bearer identifier carried in a received downlink data notification message sent by a serving gateway S-GW, an access point name APN to which the downlink data belongs, and determine the service type information according to the APN; or

determine, according to a bearer identifier carried in a received downlink data notification message sent by an S-GW, a quality of service class identifier QCI to which the downlink data belongs, and determine the service type information according to the QCI; or

determine the service type information according to a received downlink data notification message sent by an S-GW, where the downlink data notification message carries the service type information.

Specifically, the network side device is a mobility management node, for example, an MME in an LTE network or an SGSN in a 2G/3G network. The downlink data of the UE arrives at a P-GW, and the P-GW sends the downlink data to the S-GW. If the ISR of the UE is activated, the S-GW separately sends the downlink data notification message to the MME and the SGSN. The downlink data notification message may carry the bearer identifier, and the MME or the SGSN may determine, according to the bearer identifier, a service flow that triggers the paging, that is, the APN to which the downlink data belongs, and may determine a service type of the downlink data according to the APN. The MME or the SGSN may further determine, according to the bearer identifier carried in the downlink data notification message, the QCI to which the downlink data belongs, and may further determine the service type of the downlink data according to the QCI. The S-GW may further directly add the service type information to the downlink data notification message, where the service type information may specifically be carried in a GTP header of a data packet sent by the P-GW to the S-GW, or be obtained by mapping a DSCP value in a data packet.

The mobility management node may select, according to the service type of the downlink data, a network standard suitable for transmission of the downlink data; and use network standard indication information that indicates the network standard as the target network indication information, add the target network indication information to the paging message, and send the paging message to an access network device such as an eNB/BSC/RNC. The mobility management node may further determine a suitable network standard and frequency and/or cell according to the information, reported by the access network device, about the network resource situation of the access network. The network standard indicated by the target network indication information may be the same as or different from the network standard used when the UE camps in an idle state and when the UE receives the paging message.

The mobility management node may further learn whether the ISR of the UE is activated. If the ISR of the UE is activated, the network standard determined by the mobility management node may be different from the network standard used when the UE camps in the idle state and when the UE receives the paging message. If the ISR of the UE is not activated, the network standard determined by the mobility management node should be the same as the network standard used when the UE camps in the idle state and when the UE receives the paging message.

In this embodiment, the network information includes the service type information, and the network side device is a single radio controller SRC.

The acquiring unit 31 is further configured to determine the service type information according to a received second paging message sent by a mobility management node or an access network device, where the second paging message carries the service type information.

The sending unit 32 is further configured to add the target network indication information to the first paging message, and send the first paging message to the UE by using the access network device.

Specifically, the SRC may select, according to a service type of the downlink data, a network standard suitable for transmission of the downlink data; and use network standard indication information that indicates the network standard as the target network indication information, add the target network indication information to the paging message, and send the paging message to the access network device. The SRC may determine a suitable network standard and frequency and/or cell according to the information, reported by the access network device, about the network resource situation of the access network. The network standard indicated by the target network indication information may be the same as or different from the network standard used when the UE camps in an idle state and when the UE receives the paging message. The SRC may further determine the target network indication information according to one or more principles of load or of balance between user systems.

In this embodiment, the network information further includes the activation indication information that is used to indicate whether the idle state signaling reduction ISR of the UE is activated, and the network side device is a single radio controller SRC.

The acquiring unit 31 is further configured to determine the activation indication information according to a received second paging message sent by a mobility management node or an access network device, and determine the target network indication information according to the service type information and the activation indication information, where the second paging message carries the activation indication information.

The sending unit 32 is further configured to add the target network indication information to the first paging message, and send the first paging message to the UE by using the access network device.

Specifically, the SRC determines the target network indication information according to the service type information and the activation indication information, adds the target network indication information to the paging message, and sends the paging message to the access network device; the access network device then sends the paging message to the UE.

In this embodiment, the network information includes the service type information, and the network side device is an access network device.

The acquiring unit 31 is further configured to determine the service type information according to a received second paging message sent by a mobility management node or an SRC, where the second paging message carries the service type information.

Specifically, the network side device is an access network device, for example, an eNB in an LTE network, a BSC in a 2G network, or an RNC in a 3G network. In a network architecture with no SRC disposed, the access network device receives the paging message sent by the mobility management node, where the paging message carries the service type information. For a manner of determining a service type of the downlink data by the mobility management node, reference may specifically be made to the description of the embodiment in which the network side device is a mobility management node, which is not described herein again. In a network architecture with an SRC disposed, the access network device may receive the paging message sent by the SRC, where the paging message carries the service type information. The access network device may select, according to the service type of the downlink data, a network standard suitable for transmission of the downlink data; and use network standard indication information that indicates the network standard as the target network indication information, add the target network indication information to the paging message, and send the paging message to the UE. The access network device may perform detection on the network resource situation of the access network, so as to acquire the information about the network resource situation of the access network. The access network device may further determine a suitable network standard and frequency and/or cell according to the information about the network resource situation of the access network. The access network device may further add the activation indication information to the paging message received from the mobility management node or the SRC. In the foregoing process of determining the target network indication information, the access network device refers to whether the ISR of the UE is activated, so as to improve correctness of determining the target network indication information.

In this embodiment, the target network indication information includes network standard indication information, or network standard indication information and frequency indication information, or network standard indication information and cell indication information.

FIG. 6 is a schematic structural diagram of first user equipment according to an embodiment of the present invention. As shown in FIG. 6, the user equipment provided in this embodiment of the present invention may specifically implement steps of a paging method, applied to user equipment and provided in any embodiment of the present invention, in a wireless communications system, and a specific implementation process is not described herein again.

The user equipment provided in this embodiment of the present invention specifically includes:

a receiving unit 41, configured to receive a paging message that is sent by a network side device and that carries target network indication information; and

a processing unit 42, configured to determine a cell according to the target network indication information, and initiate a service request or respond to paging in the determined cell.

According to the user equipment provided in this embodiment of the present invention, a receiving unit 41 receives a paging message that is sent by a network side device and that carries target network indication information, and a processing unit 42 determines a cell according to the target network indication information, and initiates a service request or responds to paging in the determined cell. The target network indication information is carried in the paging message, so that the UE selects the cell according to the target network indication information, and initiates the service request or responds to the paging in the selected cell. This avoids restriction, on network resource allocation, caused by that the UE can only wait for paging and respond in a cell of a network standard used when the UE camps in an idle state and when the UE receives the paging message, thereby improving a paging effect.

In this embodiment, the target network indication information includes network standard indication information.

The processing unit 42 is further configured to: if the processing unit 42 determines that idle state signaling reduction ISR is activated and that a first network standard indicated by the network standard indication information is different from a second network standard used when the user equipment UE camps in an idle state and when the UE receives the paging message, select a first cell that is of the first network standard and whose signal quality meets a preset stipulation; and if the first cell is a cell in a location area with which the UE is registered, initiate the service request or respond to the paging in the first cell; or

if the processing unit 42 determines that ISR is activated and that a first network standard indicated by the network standard indication information is different from a second network standard used when the UE camps in an idle state and when the UE receives the paging message, and if signal quality of any cell of the first network standard does not meet a preset stipulation, initiate the service request or respond to the paging in a cell of the second network standard used when the UE camps in the idle state and when the UE receives the paging message; or

if the processing unit 42 determines that ISR is activated and that a first network standard indicated by the network standard indication information is different from a second network standard used when the UE camps in an idle state and when the UE receives the paging message, select a first cell that is of the first network standard and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processing unit 42 determines that ISR is activated and that a first network standard indicated by the network standard indication information is different from a second network standard used when the UE camps in an idle state and when the UE receives the paging message, select the N^{th} cell that is of the first network standard and whose signal quality meets a preset stipulation; if the N^{th} cell is not a cell in a location area with which the UE is registered, select the (N+1)^{th} cell that is of the first network standard and whose signal quality meets the preset stipulation; and if the (N+1)^{th} cell is a cell in the location area with which the UE is registered, initiate the service request or respond to the paging in the (N+1)^{th} cell, where N is an integer, 1≦N≦M, and a quantity of cells that are of the first network standard and whose signal quality meets the preset stipulation is M; or

if the processing unit 42 determines that ISR is activated and that a first network standard indicated by the network standard indication information is different from a second network standard used when the UE camps in an idle state and when the UE receives the paging message, and if none of cells that are of the first network standard and whose signal quality meets a preset stipulation is a cell in a location area with which the UE is registered, initiate the service request or respond to the paging in a cell of the second network standard used when the UE camps in the idle state and when the UE receives the paging message.

In this embodiment, the target network indication information includes network standard indication information.

The processing unit 42 is further configured to: if the processing unit 42 determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

In this embodiment, the target network indication information includes network standard indication information and frequency indication information.

The processing unit 42 is further configured to: if the processing unit 42 determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is a cell in a location area with which the UE is registered, initiate the service request or respond to the paging in the first cell; or

if the processing unit 42 determines that ISR is activated and that a first network standard indicated by the network standard indication information is different from a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processing unit 42 determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processing unit 42 determines that ISR is activated and that a first network standard indicated by the network standard indication information is different from a second network standard used when the UE camps in an idle state and when the UE receives the paging message, select the I^{th} cell that is of the first network standard, that is of a frequency indicated by the frequency indication information, and whose signal quality meets a preset stipulation; if the I^{th} cell is not a cell in a location area with which the UE is registered, select the (I+1)^{th} cell that is of the frequency and whose signal quality meets the preset stipulation; and if the (I+1)^{th} cell is a cell in the location area with which the UE is registered, initiate the service request or respond to the paging in the (I+1)^{th} cell, where I is an integer, 1≦I≦J, and a quantity of cells that are of the frequency and whose signal quality meets the preset stipulation is J; or

if the processing unit 42 determines that ISR is activated and that a first network standard indicated by the network standard indication information is different from a second network standard used when the UE camps in an idle state and when the UE receives the paging message, and if none of cells that are of the first network standard, that are of a frequency indicated by the frequency indication information, and whose signal quality meets a preset stipulation is a cell in a location area with which the UE is registered, initiate the service request or respond to the paging in a cell of the second network standard used when the UE camps in the idle state and when the UE receives the paging message.

In this embodiment, the target network indication information includes network standard indication information and frequency indication information.

The processing unit 42 is further configured to: if the processing unit 42 determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is a cell in a location area with which the UE is registered, initiate the service request or respond to the paging in the first cell; or

if the processing unit 42 determines that a first network standard indicated by the network standard indication information is the same as a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processing unit 42 determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processing unit 42 determines that a first network standard indicated by the network standard indication information is the same as a second network standard used when the UE camps in an idle state and when the UE receives the paging message, select the R^{th} cell that is of a frequency indicated by the frequency indication information and whose signal quality meets a preset stipulation; if the R^{th} cell is not a cell in a location area with which the UE is registered, select the (R+1)^{th} cell that is of the frequency and whose signal quality meets the preset stipulation; and if the (R+1)^{th} cell is a cell in the location area with which the UE is registered, initiate the service request or respond to the paging in the (R+1)^{th} cell, where R is an integer, 1≦R≦S, and a quantity of cells that are of the frequency and whose signal quality meets the preset stipulation is S.

In this embodiment, the target network indication information includes network standard indication information and cell indication information.

The processing unit 42 is further configured to: if the processing unit 42 determines that: ISR is activated, a first network standard indicated by the network standard indication information is different from a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processing unit 42 determines that ISR is activated and that a first network standard indicated by the network standard indication information is different from a second network standard used when the UE camps in an idle state and when the UE receives the paging message, and if signal quality of any first cell indicated by the cell indication information does not meet a preset stipulation, initiate the service request or respond to the paging in a cell of the second network standard used when the UE camps in the idle state and when the UE receives the paging message; or

if the processing unit 42 determines that: ISR is activated, a first network standard indicated by the network standard indication information is different from a second network standard used when the UE camps in an idle state and when the UE receives the paging message, and a first cell indicated by the cell indication information is not a cell in a location area with which the UE is registered, initiate the service request or respond to the paging in a cell of the second network standard used when the UE camps in the idle state and when the UE receives the paging message.

In this embodiment, the target network indication information includes network standard indication information and cell indication information.

The processing unit 42 is further configured to: if the processing unit 42 determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

In this embodiment, the target network indication information includes network standard indication information and cell indication information.

The processing unit 42 is further configured to: if the processing unit 42 determines that: a first network standard indicated by the network standard indication information is the same as a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processing unit 42 determines that a first network standard indicated by the network standard indication information is the same as a second network standard used when the UE camps in an idle state and when the UE receives the paging message, and if signal quality of a first cell indicated by the cell indication information does not meet a preset stipulation, initiate the service request or respond to the paging in a cell of the second network standard used when the UE camps in the idle state and when the UE receives the paging message; or

if the processing unit 42 determines that a first network standard indicated by the network standard indication information is the same as a second network standard used when the UE camps in an idle state and when the UE receives the paging message, and if a first cell indicated by the cell indication information is not a cell in a location area with which the UE is registered, initiate the service request or respond to the paging in a cell of the second network standard used when the UE camps in the idle state and when the UE receives the paging message.

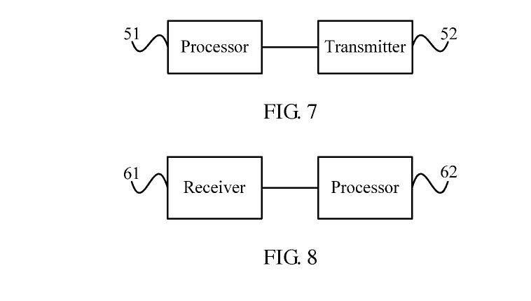

FIG. 7 is a schematic structural diagram of a second network side device according to an embodiment of the present invention. As shown in FIG. 7, the network side device provided in this embodiment may specifically implement steps of a paging method, applied to a network side device and provided in any embodiment of the present invention, in a wireless communications system, and a specific implementation process is not described herein again.

The network side device provided in this embodiment specifically includes:

a processor 51, configured to acquire network information and determine target network indication information according to the network information; and

a transmitter 52, configured to add the target network indication information to a first paging message, and send the first paging message to user equipment UE, so that the UE determines a cell according to the target network indication information, and initiates a service request or responds to paging in the determined cell.

According to the network side device provided in this embodiment, a processor 51 acquires network information and determines target network indication information according to the network information; and a transmitter 52 adds the target network indication information to a paging message, and sends the paging message to user equipment UE. The target network indication information is carried in the paging message, so that the UE selects a cell according to the target network indication information, and initiates a service request or responds to paging in the selected cell. This avoids restriction, on network resource allocation, caused by that the UE can only wait for paging and respond in a cell of a network standard used when the UE camps in an idle state and when the UE receives the paging message, thereby improving a paging effect.

In this embodiment, the network information may include at least one of the following:

service type information of downlink data that triggers the paging and information about a network resource situation of an access network.

In this embodiment, the network information may further include activation indication information that is used to indicate whether ISR of the UE is activated.

In this embodiment, the network information includes the service type information, and the network side device is a mobility management node.

The processor 51 is further configured to determine, according to a bearer identifier carried in a received downlink data notification message sent by a serving gateway S-GW, an access point name APN to which the downlink data belongs, and determine the service type information according to the APN; or

determine, according to a bearer identifier carried in a received downlink data notification message sent by an S-GW, a quality of service class identifier QCI to which the downlink data belongs, and determine the service type information according to the QCI; or

determine the service type information according to a received downlink data notification message sent by an S-GW, where the downlink data notification message carries the service type information.

In this embodiment, the network information includes the service type information, and the network side device is a single radio controller SRC.

The processor 51 is further configured to determine the service type information according to a received second paging message sent by a mobility management node or an access network device, where the second paging message carries the service type information.

The transmitter 52 is further configured to add the target network indication information to the first paging message, and send the first paging message to the UE by using the access network device.

In this embodiment, the network information further includes the activation indication information that is used to indicate whether the idle state signaling reduction ISR of the UE is activated, and the network side device is a single radio controller SRC.

The processor 51 is further configured to determine the activation indication information according to a received second paging message sent by a mobility management node or an access network device, and determine the target network indication information according to the service type information and the activation indication information, where the second paging message carries the activation indication information.

The transmitter 52 is further configured to add the target network indication information to the first paging message, and send the first paging message to the UE by using the access network device.

In this embodiment, the network information includes the service type information, and the network side device is an access network device.

The processor 51 is further configured to determine the service type information according to a received second paging message sent by a mobility management node or an SRC, where the second paging message carries the service type information.

In this embodiment, the target network indication information includes network standard indication information, or network standard indication information and frequency indication information, or network standard indication information and cell indication information.

FIG. 8 is a schematic structural diagram of second user equipment according to an embodiment of the present invention. As shown in FIG. 8, the user equipment provided in this embodiment of the present invention may specifically implement steps of a paging method, applied to user equipment and provided in any embodiment of the present invention, in a wireless communications system, and a specific implementation process is not described herein again.

The user equipment provided in this embodiment of the present invention specifically includes:

a receiver 61, configured to receive a paging message that is sent by a network side device and that carries target network indication information; and

a processor 62, configured to determine a cell according to the target network indication information, and initiate a service request or respond to paging in the determined cell.

According to the user equipment provided in this embodiment of the present invention, a receiver 61 receives a paging message that is sent by a network side device and that carries target network indication information, and a processor 62 determines a cell according to the target network indication information, and initiates a service request or responds to paging in the determined cell. The target network indication information is carried in the paging message, so that the UE selects the cell according to the target network indication information, and initiates the service request or responds to the paging in the selected cell. This avoids restriction, on network resource allocation, caused by that the UE can only wait for paging and respond in a cell of a network standard used when the UE camps in an idle state and when the UE receives the paging message, thereby improving a paging effect.

In this embodiment, the target network indication information includes network standard indication information.

The processor 62 is further configured to: if the processor 62 determines that idle state signaling reduction ISR is activated and that a first network standard indicated by the network standard indication information is different from a second network standard used when the user equipment UE camps in an idle state and when the UE receives the paging message, select a first cell that is of the first network standard and whose signal quality meets a preset stipulation; and if the first cell is a cell in a location area with which the UE is registered, initiate the service request or respond to the paging in the first cell; or

if the processor 62 determines that ISR is activated and that a first network standard indicated by the network standard indication information is different from a second network standard used when the UE camps in an idle state and when the UE receives the paging message, and if signal quality of any cell of the first network standard does not meet a preset stipulation, initiate the service request or respond to the paging in a cell of the second network standard used when the UE camps in the idle state and when the UE receives the paging message; or

if the processor 62 determines that ISR is activated and that a first network standard indicated by the network standard indication information is different from a second network standard used when the UE camps in an idle state and when the UE receives the paging message, select a first cell that is of the first network standard and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processor 62 determines that ISR is activated and that a first network standard indicated by the network standard indication information is different from a second network standard used when the UE camps in an idle state and when the UE receives the paging message, select the N^{th} cell that is of the first network standard and whose signal quality meets a preset stipulation; if the N^{th} cell is not a cell in a location area with which the UE is registered, select the (N+1)^{th} cell that is of the first network standard and whose signal quality meets the preset stipulation; and if the (N+1)^{th} cell is a cell in the location area with which the UE is registered, initiate the service request or respond to the paging in the (N+1)^{th} cell, where N is an integer, 1≦N≦M, and a quantity of cells that are of the first network standard and whose signal quality meets the preset stipulation is M; or

if the processor 62 determines that ISR is activated and that a first network standard indicated by the network standard indication information is different from a second network standard used when the UE camps in an idle state and when the UE receives the paging message, and if none of cells that are of the first network standard and whose signal quality meets a preset stipulation is a cell in a location area with which the UE is registered, initiate the service request or respond to the paging in a cell of the second network standard used when the UE camps in the idle state and when the UE receives the paging message.

In this embodiment, the target network indication information includes network standard indication information.

The processor 62 is further configured to: if the processor 62 determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

In this embodiment, the target network indication information includes network standard indication information and frequency indication information.

The processor 62 is further configured to: if the processor 62 determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is a cell in a location area with which the UE is registered, initiate the service request or respond to the paging in the first cell; or

if the processor 62 determines that ISR is activated and that a first network standard indicated by the network standard indication information is different from a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processor 62 determines that ISR is activated and that a first network standard indicated by the network standard indication information is different from a second network standard used when the UE camps in an idle state and when the UE receives the paging message, select a first cell that is of the first network standard, that is of a frequency indicated by the frequency indication information, and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processor 62 determines that ISR is activated and that a first network standard indicated by the network standard indication information is different from a second network standard used when the UE camps in an idle state and when the UE receives the paging message, select the I^{th} cell that is of the first network standard, that is of a frequency indicated by the frequency indication information, and whose signal quality meets a preset stipulation; if the I^{th} cell is not a cell in a location area with which the UE is registered, select the (I+1)^{th} cell that is of the frequency and whose signal quality meets the preset stipulation; and if the (I+1)^{th} cell is a cell in the location area with which the UE is registered, initiate the service request or respond to the paging in the (I+1)^{th} cell, where I is an integer, 1≦I≦J, and a quantity of cells that are of the frequency and whose signal quality meets the preset stipulation is J; or

if the processor 62 determines that ISR is activated and that a first network standard indicated by the network standard indication information is different from a second network standard used when the UE camps in an idle state and when the UE receives the paging message, and if none of cells that are of the first network standard, that are of a frequency indicated by the frequency indication information, and whose signal quality meets a preset stipulation is a cell in a location area with which the UE is registered, initiate the service request or respond to the paging in a cell of the second network standard used when the UE camps in the idle state and when the UE receives the paging message.

In this embodiment, the target network indication information includes network standard indication information and frequency indication information.

The processor 62 is further configured to: if the processor 62 determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is a cell in a location area with which the UE is registered, initiate the service request or respond to the paging in the first cell; or

if the processor 62 determines that a first network standard indicated by the network standard indication information is the same as a second network standard used when the UE camps in an idle state and when the UE receives the paging message, and if signal quality of any cell that is of the first network standard and that is of a frequency indicated by the frequency indication information does not meet a preset stipulation, initiate the service request or respond to the paging in a cell of the second network standard used when the UE camps in the idle state and when the UE receives the paging message; or

if the processor 62 determines that a first network standard indicated by the network standard indication information is the same as a second network standard used when the UE camps in an idle state and when the UE receives the paging message, select a first cell that is of a frequency indicated by the frequency indication information and whose signal quality meets a preset stipulation; and if the first cell is not a cell in a location area with which the UE is registered, initiate the service request or respond to the paging in a cell of the second network standard used when the UE camps in the idle state and when the UE receives the paging message; or

if the processor 62 determines that a first network standard indicated by the network standard indication information is the same as a second network standard used when the UE camps in an idle state and when the UE receives the paging message, select the R^{th} cell that is of a frequency indicated by the frequency indication information and whose signal quality meets a preset stipulation; if the R^{th} cell is not a cell in a location area with which the UE is registered, select the (R+1)^{th} cell that is of the frequency and whose signal quality meets the preset stipulation; and if the (R+1)^{th} cell is a cell in the location area with which the UE is registered, initiate the service request or respond to the paging in the (R+1)^{th} cell, where R is an integer, 1≦R≦S, and a quantity of cells that are of the frequency and whose signal quality meets the preset stipulation is S.

In this embodiment, the target network indication information includes network standard indication information and cell indication information.

The processor 62 is further configured to: if the processor 62 determines that: ISR is activated, a first network standard indicated by the network standard indication information is different from a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processor 62 determines that ISR is activated and that a first network standard indicated by the network standard indication information is different from a second network standard used when the UE camps in an idle state and when the UE receives the paging message, and if signal quality of any first cell indicated by the cell indication information does not meet a preset stipulation, initiate the service request or respond to the paging in a cell of the second network standard used when the UE camps in the idle state and when the UE receives the paging message; or

if the processor 62 determines that: ISR is activated, a first network standard indicated by the network standard indication information is different from a second network standard used when the UE camps in an idle state and when the UE receives the paging message, and a first cell indicated by the cell indication information is not a cell in a location area with which the UE is registered, initiate the service request or respond to the paging in a cell of the second network standard used when the UE camps in the idle state and when the UE receives the paging message.

In this embodiment, the target network indication information includes network standard indication information and cell indication information.

The processor 62 is further configured to: if the processor 62 determines that ISR is not activated and that a first network standard indicated by the network standard indication information is different from a second network standard used when the UE camps in an idle state and when the UE receives the paging message, initiate the service request or respond to the paging in a cell of the second network standard used when the UE camps in the idle state and when the UE receives the paging message.

In this embodiment, the target network indication information includes network standard indication information and cell indication information.

The processor 62 is further configured to: if the processor 62 determines that: a first network standard indicated by the network standard indication information is the same as a second network standard used when the UE camps in an idle state and when the UE receives the paging message, signal quality of a first cell indicated by the cell indication information meets a preset stipulation, and the first cell is a cell in a location area with which the UE is registered, initiate the service request or respond to the paging in the first cell; or

if the processor 62 determines that a first network standard indicated by the network standard indication information is the same as a second network standard used when the UE camps in an idle state and when the UE receives the paging message, and if signal quality of a first cell indicated by the cell indication information does not meet a preset stipulation, initiate the service request or respond to the paging in a cell of the second network standard used when the UE camps in the idle state and when the UE receives the paging message; or

if the processor 62 determines that a first network standard indicated by the network standard indication information is the same as a second network standard used when the UE camps in an idle state and when the UE receives the paging message, and if a first cell indicated by the cell indication information is not a cell in a location area with which the UE is registered, initiate the service request or respond to the paging in a cell of the second network standard used when the UE camps in the idle state and when the UE receives the paging message.

Persons of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A paging method in a wireless communications system, comprising:
acquiring, by a network side device, network information;
determining, by a network side device, target network indication information according to the network information;
adding, by the network side device, the target network indication information to a first paging message; and
sending the first paging message to a user equipment (UE), so that the UE determines a cell according to the target network indication information, and so that the UE initiates a service request in the determined cell or responds to paging in the determined cell.

2. The paging method in a wireless communications system according to claim 1, wherein the network information comprises at least one of service type information of downlink data that triggers the paging and information about a network resource situation of an access network.

3. The paging method in a wireless communications system according to claim 2, wherein the network information comprises the service type information, and the network side device is a mobility management node; and
wherein the acquiring, by the network side device, network information comprises performing at least one of:
determining, by the mobility management node and according to a bearer identifier carried in a received downlink data notification message sent by a serving gateway (S-GW), an access point name (APN) to which the downlink data belongs, and determining the service type information according to the APN; or
determining, by the mobility management node according to a bearer identifier carried in a received downlink data notification message sent by an S-GW, a quality of service class identifier (QCI) to which the downlink data belongs, and determining the service type information according to the QCI; or
determining, by the mobility management node, the service type information according to a received downlink data notification message sent by an S-GW, wherein the downlink data notification message carries the service type information.

4. The paging method in a wireless communications system according to claim 2, wherein the network information comprises the service type information, and the network side device is a single radio controller (SRC);
wherein the acquiring, by the network side device, network information comprises:
determining, by the SRC, the service type information according to a received second paging message sent by a mobility management node or an access network device, wherein the second paging message carries the service type information; and
wherein the adding, by the network side device, the target network indication information to a first paging message, and sending the first paging message to user equipment (UE) comprises:
adding, by the SRC, the target network indication information to the first paging message, and sending the first paging message to the UE by using the access network device.

5. The paging method in a wireless communications system according to claim 2, wherein the network information further comprises activation indication information that indicates whether idle mode signaling reduction ISR of the UE is activated;
wherein the network side device is a SRC;
wherein the acquiring, by a network side device, network information and determining target network indication information according to the network information comprises:
determining, by the SRC, the activation indication information according to a received second paging message sent by a mobility management node or an access network device; and
determining the target network indication information according to the service type information and the activation indication information, wherein the second paging message carries the activation indication information; and
wherein the adding, by the network side device, the target network indication information to a first paging message, and sending the first paging message to user equipment (UE) comprises:
adding, by the SRC, the target network indication information to the first paging message; and
sending the first paging message to the UE by using the access network device.

6. The paging method in a wireless communications system according to claim 2, wherein the network information comprises the service type information;
wherein the network side device is an access network device; and
wherein the acquiring, by a network side device, network information comprises:
determining, by the access network device, the service type information according to a received second paging message sent by a mobility management node or an SRC, wherein the second paging message carries the service type information.

7. A network side device, comprising:
a processor,
a non-transitory computer readable medium connected to the processor and having stored thereon instructions that, when executed, cause the processor to:
acquire network information and determine target network indication information according to the network information; and
a transmitter, connected to the processor, the transmitter configured to add the target network indication information to a first paging message, the transmitter further configured to send the first paging message to user equipment (UE) so that the UE determines a cell according to the target network indication information, and so that the UE initiates a service request in the determined cell or responds to paging in the determined cell.

8. The network side device according to claim 7, wherein the network information comprises at least one of service type information of downlink data that triggers the paging and information about a network resource situation of an access network.

9. The network side device according to claim 8, wherein the network information comprises the service type information, and the network side device is a mobility management node; and
wherein the non-transitory computer readable medium further has stored thereon instructions that, when executed, cause the processor to perform at least one of:
determine, according to a bearer identifier carried in a received downlink data notification message sent by a serving gateway (S-GW), an access point name (APN) to which the downlink data belongs, and determine the service type information according to the APN; or
determine, according to a bearer identifier carried in a received downlink data notification message sent by an S-GW, a quality of service class identifier (QCI) to which the downlink data belongs, and determine the service type information according to the QCI; or
determine the service type information according to a received downlink data notification message sent by an S-GW, wherein the downlink data notification message carries the service type information.

10. The network side device according to claim 8, wherein the network information comprises the service type information, and the network side device is a single radio controller (SRC);
wherein the non-transitory computer readable medium further has stored thereon instructions that, when executed, cause the processor to determine the service type information according to a received second paging message sent by a mobility management node or an access network device, wherein the second paging message carries the service type information; and
wherein the transmitter is further configured to add the target network indication information to the first paging message, and send the first paging message to the UE by using the access network device.

11. The network side device according to claim 8, wherein the network information further comprises activation indication information that is used to indicate whether idle state signaling reduction ISR of the UE is activated, and the network side device is an SRC;
wherein the non-transitory computer readable medium further has stored thereon instructions that, when executed, cause the processor to:
determine the activation indication information according to a received second paging message sent by a mobility management node or an access network device; and
determine the target network indication information according to the service type information and the activation indication information, wherein the second paging message carries the activation indication information; and
wherein the transmitter is further configured to add the target network indication information to the first paging message, and send the first paging message to the UE by using the access network device.

12. The network side device according to claim 8, wherein the network information comprises the service type information, and the network side device is an access network device; and
wherein the non-transitory computer readable medium further has stored thereon instructions that, when executed, cause the processor to determine the service type information according to a received second paging message sent by a mobility management node or an SRC, wherein the second paging message carries the service type information.

13. A user equipment (UE), comprising:
a receiver, configured to receive a paging message that is sent by a network side device and that carries target network indication information; and
a processor connected to the receiver; and
a non-transitory computer readable medium connected to the processor and having stored thereon instructions that, when executed, cause the processor to:
determine a cell according to the target network indication information; and
initiate a service request or respond to paging in the determined cell.

14. The user equipment according to claim 13, wherein the target network indication information comprises network standard indication information; and
wherein the non-transitory computer readable medium further has stored thereon instructions that, when executed, cause the processor to perform at least one of:
select a first cell that is of a first network standard and whose signal quality meets a preset stipulation in response to determining that idle state signaling reduction (ISR) is activated and that the first network standard indicated by the network standard indication information is different from a second network standard used when the UE camps in an idle state and when the UE receives a paging message, and in response to the first cell being a cell in a location area with which the UE is registered, initiate the service request or respond to the paging in the first cell; or
initiate the service request or respond to paging in a cell of the second network standard used when the UE camps in an idle state and when the UE receives a paging message in response to determining that ISR is activated and that a first network standard indicated by the network standard indication information is different from a second network standard used when the UE camps in the idle state and when the UE receives the paging message, and further in response to signal quality of any cell of the first network standard not meeting a preset stipulation; or
select a first cell that is of the first network standard and whose signal quality meets a preset stipulation in response to if determining that ISR is activated and that a first network standard indicated by the network standard indication information is different from a second network standard used when the UE camps in an idle state and when the UE receives the paging message, and in response to the first cell not being a cell in a location area with which the UE is registered, initiate the service request or respond to the paging in a cell of the second network standard used when the UE camps in the idle state and when the UE receives the paging message; or
select an N^{th} cell that is of the first network standard and whose signal quality meets a preset stipulation in response to determining that ISR is activated and that a first network standard indicated by the network standard indication information is different from a second network standard used when the UE camps in an idle state and when the UE receives the paging message, select an (N+1)^{th} cell that is of the first network standard and whose signal quality meets the preset stipulation in response to the N^{th} cell not being a cell in a location area with which the UE is registered, and initiate the service request or respond to the paging in the (N+1)^{th} cell in response to the (N+1)^{th} cell being a cell in the location area with which the UE is registered, wherein N is an integer, 1≦N≦M, and a quantity of cells that are of the first network standard and whose signal quality meets the preset stipulation is M; or
initiate the service request or respond to the paging in a cell of the second network standard used when the UE camps in an idle state and when the UE receives the paging message in response to determining that ISR is activated and that a first network standard indicated by the network standard indication information is different from a second network standard used when the UE camps in the idle state and when the UE receives the paging message, and further in response to none of cells that are of the first network standard and whose signal quality meets a preset stipulation being a cell in a location area with which the UE is registered.

15. The user equipment according to claim 13, wherein the target network indication information comprises network standard indication information; and
wherein the non-transitory computer readable medium further has stored thereon instructions that, when executed, cause the processor to:
initiate the service request or respond to the paging in a cell of a second network standard used when the UE camps in an idle state and when the UE receives the paging message in response to determining that ISR is not activated and that a first network standard indicated by the network standard indication information is different from the second network standard used when the UE camps in the idle state and when the UE receives the paging message.

16. The user equipment according to claim 13, wherein the target network indication information comprises network standard indication information and frequency indication information; and
wherein the non-transitory computer readable medium further has stored thereon instructions that, when executed, cause the processor to perform at least one of:
select a first cell that is of the first network standard, that is of a frequency indicated by the frequency indication information, and whose signal quality meets a preset stipulation in response to determining that ISR is activated and that a first network standard indicated by the network standard indication information is different from a second network standard used when the UE camps in an idle state and when the UE receives the paging message, and initiate the service request or respond to the paging in the first cell in response to the first cell being a cell in a location area with which the UE is registered; or
initiate the service request or respond to the paging in a cell of the second network standard used when the UE camps in an idle state and when the UE receives the paging message in response to determining that ISR is activated and that a first network standard indicated by the network standard indication information is different from a second network standard used when the UE camps in the idle state and when the UE receives the paging message, and further in response to signal quality of any cell that is of the first network standard and that is of a frequency indicated by the frequency indication information not meeting a preset stipulation; or
select a first cell that is of the first network standard, that is of a frequency indicated by the frequency indication information, and whose signal quality meets a preset stipulation in response to determining that ISR is activated and that a first network standard indicated by the network standard indication information is different from a second network standard used when the UE camps in an idle state and when the UE receives the paging message, and initiate the service request or respond to the paging in a cell of the second network standard used when the UE camps in the idle state and when the UE receives the paging message in response to the first cell not being a cell in a location area with which the UE is registered; or
select an I^{th} cell that is of the first network standard, that is of a frequency indicated by the frequency indication information, and whose signal quality meets a preset stipulation in response to determining that ISR is activated and that a first network standard indicated by the network standard indication information is different from a second network standard used when the UE camps in an idle state and when the UE receives the paging message, and select an (I+1)^{th} cell that is of the frequency and whose signal quality meets the preset stipulation in response to the I^{th} cell not being a cell in a location area with which the UE is registered, and initiate the service request or respond to the paging in the (I+1)^{th} cell in response to the (I+1)^{th} cell being a cell in the location area with which the UE is registered, wherein I is an integer, 1≦I≦J, and a quantity of cells that are of the frequency and whose signal quality meets the preset stipulation is J; or
initiate the service request or respond to the paging in a cell of the second network standard used when the UE camps in an idle state and when the UE receives the paging message in response to determining that ISR is activated and that a first network standard indicated by the network standard indication information is different from a second network standard used when the UE camps in the idle state and when the UE receives the paging message, and further in response to none of cells being of the first network standard, being of a frequency indicated by the frequency indication information, and whose signal quality meets a preset stipulation is a cell in a location area with which the UE is registered.

17. The user equipment according to claim 13, wherein the target network indication information comprises network standard indication information and frequency indication information; and
wherein the non-transitory computer readable medium further has stored thereon instructions that, when executed, cause the processor to perform at least one of:
select a first cell that is of a frequency indicated by the frequency indication information and whose signal quality meets a preset stipulation in response to determining that a first network standard indicated by the network standard indication information is the same as a second network standard used when the UE camps in an idle state and when the UE receives the paging message, and initiate the service request or respond to the paging in the first cell in response to the first cell being a cell in a location area with which the UE is registered; or
initiate the service request or respond to the paging in a cell of the second network standard used when the UE camps in an idle state and when the UE receives the paging message in response to determining that a first network standard indicated by the network standard indication information is the same as a second network standard used when the UE camps in the idle state and when the UE receives the paging message, and further in response to signal quality of any cell that is of the first network standard and that is of a frequency indicated by the frequency indication information not meeting the preset stipulation; or
select a first cell that is of a frequency indicated by the frequency indication information and whose signal quality meets a preset stipulation in response to determining that a first network standard indicated by the network standard indication information is the same as a second network standard used when the UE camps in an idle state and when the UE receives the paging message, and initiate the service request or respond to the paging in a cell of the second network standard used when the UE camps in the idle state and when the UE receives the paging message in response to the first cell not being a cell in a location area with which the UE is registered; or
select an R^{th} cell that is of a frequency indicated by the frequency indication information and whose signal quality meets a preset stipulation in response to determining that a first network standard indicated by the network standard indication information is the same as a second network standard used when the UE camps in an idle state and when the UE receives the paging message, and select an (R+1)^{th} cell that is of the frequency and whose signal quality meets the preset stipulation in response to the R^{th} cell not being a cell in a location area with which the UE is registered, and initiate the service request or respond to the paging in the (R+1)^{th} cell in response to the (R+1)^{th} cell being a cell in the location area with which the UE is registered, wherein R is an integer, 1≦R≦S, and a quantity of cells that are of the frequency and whose signal quality meets the preset stipulation is S.

18. The user equipment according to claim 13, wherein the target network indication information comprises network standard indication information and cell indication information; and
wherein the non-transitory computer readable medium further has stored thereon instructions that, when executed, cause the processor to perform at least one of:
initiate the service request or respond to the paging in the first cell in response to determining that ISR is activated, determining that a first network standard indicated by the network standard indication information is different from a second network standard used when the UE camps in an idle state and when the UE receives the paging message, determining that signal quality of a first cell indicated by the cell indication information meets a preset stipulation, and determining that the first cell is a cell in a location area with which the UE is registered; or
initiate the service request or respond to the paging in a cell of the second network standard used when the UE camps in an idle state and when the UE receives the paging message in response to determining that ISR is activated and that a first network standard indicated by the network standard indication information is different from a second network standard used when the UE camps in the idle state and when the UE receives the paging message, and further in response to signal quality of any first cell indicated by the cell indication information not meeting a preset stipulation; or
initiate the service request or respond to the paging in a cell of the second network standard used when the UE camps in an idle state and when the UE receives the paging message in response to determining that ISR is activated, determining that a first network standard indicated by the network standard indication information is different from a second network standard used when the UE camps in the idle state and when the UE receives the paging message, and determining that a first cell indicated by the cell indication information is not a cell in a location area with which the UE is registered.

19. The user equipment according to claim 13, wherein the target network indication information comprises network standard indication information and cell indication information; and
wherein the non-transitory computer readable medium further has stored thereon instructions that, when executed, cause the processor to:
initiate the service request or respond to the paging in a cell of the second network standard used when the UE camps in an idle state and when the UE receives the paging message in response to determining that ISR is not activated and that a first network standard indicated by the network standard indication information is different from a second network standard used when the UE camps in the idle state and when the UE receives the paging message.

20. The user equipment according to claim 13, wherein the target network indication information comprises network standard indication information and cell indication information; and
wherein the non-transitory computer readable medium further has stored thereon instructions that, when executed, cause the processor to:
initiate the service request or respond to the paging in the first cell in response to determining that a first network standard indicated by the network standard indication information is the same as a second network standard used when the UE camps in an idle state and when the UE receives the paging message, determining that signal quality of a first cell indicated by the cell indication information meets a preset stipulation, and determining that the first cell is a cell in a location area with which the UE is registered; or
initiate the service request or respond to the paging in a cell of the second network standard used when the UE camps in an idle state and when the UE receives the paging message in response to determining that a first network standard indicated by the network standard indication information is the same as a second network standard used when the UE camps in the idle state and when the UE receives the paging message, and further in response to signal quality of a first cell indicated by the cell indication information not meeting a preset stipulation; or
initiate the service request or respond to the paging in a cell of the second network standard used when the UE camps in an idle state and when the UE receives the paging message in response to determining that a first network standard indicated by the network standard indication information is the same as a second network standard used when the UE camps in the idle state and when the UE receives the paging message, and further in response to a first cell indicated by the cell indication information not being a cell in a location area with which the UE is registered.
